(19) United States
(12) Patent Application Publication
(10) Pub. No.: US 2023/0399569 A1
(43) Pub. Date: Dec. 14, 2023

(54) AN AGGLOMERATION-BASED OIL-WATER SEPARATION PROCESS

(71) Applicant: HIS MAJESTY THE KING IN RIGHT OF CANADA AS REPRESENTED BY THE MINISTER OF NATURAL RESOURCES, Ottawa (CA)

(72) Inventors: Evgeniya HRISTOVA, Edmonton (CA); Stanislav STOYANOV, Edmonton (CA)

(73) Assignee: HIS MAJESTY THE KING IN RIGHT OF CANADA AS REPRESENTED BY THE MINISTER OF NATURAL RESOURCES, Ottawa, ON (CA)

(21) Appl. No.: 18/033,854

(22) PCT Filed: Nov. 1, 2021
(86) PCT No.: PCT/CA2021/051542

§ 371 Date: Apr. 26, 2023

Related U.S. Application Data
(60) Provisional application No. 63/108,662, filed on Nov. 2, 2020.
(60) Provisional application No. 63/196,731, filed on Jun. 4, 2021.

(51) Int. Cl. C10G 1/04

(52) U.S. Cl. CPC C10G 1/045; C10G 2300/802

(57) ABSTRACT

The present application provides a method for bitumen froth treatment in the transition region between coalescence and agglomeration. The method involves separating diluted bitumen product from a bitumen froth mixture, comprising the bitumen, water and mineral solids, the method comprising: (a) combining the mixture with a solvent blend to obtain a combination having a ratio of said solvent blend to the bitumen of about 1.0-1.6 by mass, wherein said solvent blend comprises from 2.2-4.5 (±0.2) wt % aromatic solvent or from 70-80 (±10) wt % paraffinic solvent; (b) mixing the combination; and (c) separating the diluted bitumen product from the water and mineral solids.

### RELATED APPLICATION

This application claims the benefit of the filing date of U.S. Application No. 63/108,662, filed on 2 Nov. 2020, and U.S. Patent Application No. 63/196,731, filed on 4 Jun. 2021, the contents of which are each incorporated herein by reference in their entireties.

### FIELD OF THE INVENTION

The present application pertains to the field of bitumen treatment. More particularly, the present application relates to an agglomeration-based oil-water separation process, for example, for use in bitumen froth treatment in bitumen recovery from oil sands.

### INTRODUCTION

The Province of Alberta in Western Canada hosts the world's third largest petroleum deposits after Saudi Arabia and Venezuela. These deposits are located in both oil sands and carbonate formations. The oil sands are unconsolidated sand deposits containing a highly viscous and asphaltene-rich petroleum known as bitumen. Commercially, bitumen is recovered from oil sands using surface mining from shallow deposits and in situ from deep deposits[1, 2]. In surface mining, the oil sands are subjected to a warm water extraction with aeration to generate an intermediate product known as bitumen froth. The bitumen froth, typically containing 60 wt % bitumen, 30 wt % water and 10 wt % solids, is treated with organic solvents to separate the target organic bitumen product from the mineral solids and water [3,4,5].

Residual water and mineral solids are detrimental to pipeline transport and downstream processes such as upgrading and refining. The detrimental effects of solids are due to blocking pores and the poisoning of catalysts in downstream processes. The detrimental effect of water is due to the dissolved salts (e.g., NaCl), that create serious corrosion problems in pipelines and downstream operations. The chloride salts come from the oil sands feed, accumulate in the process water as it is recycled and upon hydrotreatment, and are converted into hydrochloric acid, which is corrosive [2,6]

Paraffinic froth treatment (PFT) and naphthenic froth treatment (NFT) processes are commercially employed by the surface mining oil sands industry [7,8,9]. The fundamental difference between these processes is the type and amount of solvent added. In PFT, an aliphatic hydrocarbon solvent, such as a gas condensate, is added at a solvent-to-bitumen (S/B, by volume) ratio of approximately 1.6, compared to only 0.6 in NFT [10,11]. The absence of aromatics and naphthenes in the paraffinic solvent results in the partial precipitation of the bitumen's asphaltene fraction. The asphaltene precipitation spontaneously induces the formation of large agglomerates that also incorporate the residual solids and water from the diluted bitumen [12, 13, 14], hence, the separation occurs by spontaneous agglomeration (FIG. 1 top). The PFT process is based primarily on the gravitational settling of those agglomerates and delivers a bitumen product virtually free from residual water and solids. In PFT separation vessels, the lower density diluted bitumen product is continuously collected from the top of the vessels and the froth treatment tailings, containing residual solids, water and precipitated asphaltene, are removed from the bottom [15,16]. The main drawbacks of PFT in comparison with conventional NFT are an increased throughput due to the higher S/B ratio, a substantial product loss due to the partial asphaltene precipitation, and the generation of hydrocarbon-rich tailings [8,13].

In NFT, naphtha-based solvents contain a variety of aromatic and naphthenic components, typically from C₆ to C₁₂, such as benzene, toluene, xylene, cyclohexane or others. The high aromatic and naphthenic contents of naphtha prevent asphaltene precipitation and the asphaltenes are retained in the bitumen product, increasing the overall hydrocarbon recovery [8,17,18]. Under these conditions, the oil-water separation occurs by the coalescence of water droplets (FIG. 1 bottom), a mechanism that does not substantially affect the solids and asphaltenes [19]. Separation by gravity settling alone at an S/B ratio near yields a diluted bitumen product with residual water and solid contents of 2-5 wt % and wt %, respectively [5,8, 20,1,22]. The bitumen produced using NFT requires further treatment by centrifugation, chemical addition, and polishing steps to remove the residual solids and water. The NFT process is conducted at elevated temperatures of 75-85° C. in order to facilitate the action of demulsifiers in the chemical addition steps [23,24,25,26,27]. These separation steps lead to increased overall capital costs, energy use and processing time [28,29].

Oil sand producers often experience oil-water separation challenges, such as the formation of stable emulsions and rag layers, arising from the unwanted occurrence of spontaneous agglomeration. These challenges arise from what is perceived as a random asphaltene precipitation, when in some cases of low aromatic content and at certain S/B ratios the naphtha may exhibit paraffinic behavior in terms of asphaltene precipitation. This change in emulsion behavior, augmented by the fact that the aromatic and paraffinic contents of commercial naphtha vary significantly [8,16,30,31], may appear random only because the effect of paraffinic hydrocarbons on asphaltene precipitation at the nano-scale is not fully understood. Bearing in mind that the majority of the oil recovery processes are coalescence-based, a deeper understanding of the nature of the oil-water separation is required, as well as a better understanding of the conditions at which coalescence may be inhibited and spontaneous agglomeration is initiated [32,33,34,35].

A need remains for a bitumen froth treatment process that combines the advantages and eliminates the drawbacks of NFT and PFT, and has a decreased environmental impact.

The above information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present application is to provide an agglomeration-based oil-water separation process, for example, as a method for bitumen froth treatment.

In accordance with an aspect of the present application, there is provided a method for oil-water separation. In one embodiment, the method is for obtaining diluted bitumen or bitumen from a bitumen-containing mixture, for example, bitumen froth, said method comprising: (a) combining the bitumen-containing mixture with a solvent blend to obtain a combination having a ratio of said solvent blend to bitumen of about 1.0-1.6 by mass, wherein said solvent blend comprises one or more aromatic components and one or more paraffinic components in an amount of from about 60 to about 90 wt % paraffinic solvent; (b) mixing the combination; and (c) separating the diluted bitumen from the water and mineral solids. In some embodiments, the aromatic solvent is present in the solvent blend at in an amount of from about 2.0 to about 4.7 wt %.

### BRIEF DESCRIPTION OF TABLES AND FIGURES

For a better understanding of the application as described herein, as well as other aspects and further features thereof, reference is made to the following description which is to be used in conjunction with the accompanying drawings.

FIG. 1 depicts agglomeration (top) of water droplets, asphaltene aggregates (in black) and mineral solids (light grey) and coalescence (bottom), which is a merging of small water droplets into larger water droplets until large water domains are formed.

FIG. 2 graphically depicts the process for bitumen froth treatment performed in the transition region that exists between NFT and PFT.

FIG. 3 graphically depicts the concentration of hydrocarbon types in naphtha A and B used in Example 1.

FIG. 4 depicts the settling setup used in Example 1: a) Image view with fibre-optic light illumination for visual observation of the settling interface; b) Scheme of the subsampling levels of the overflow (top, middle and bottom) and underflow (tailings). Subsampling is performed after 1 h of settling. The middle-level sampling is set at 60% of the total settling distance, indicated with an arrow in b).

FIG. 5 graphically depicts total aromatic (top) and total paraffinic (bottom) contents of the naphtha in pentane (naphtha/C₅) solvent blends containing naphtha A and B.

FIG. 6 graphically depicts settling behavior of bitumen froth A (A; top) and B (B; bottom) treated with naphtha in pentane (naphtha/C₅) blends at S/B ratio of 1.6. Fast Initial Settling at 0-10 vol % and 0-15 vol % naphtha/C₅ for samples A and B, respectively; Gradual Linear Settling (highlighted with a curly bracket) at 15-40 vol % and 20-50 vol % naphtha/C₅ for samples A and B, respectively; No Visual Settling at 60-100 vol % naphtha/C₅.

FIG. 7 graphically depicts water distribution in the overflow (diluted bitumen product) at the top, middle and bottom settling levels (FIG. 4b) after froth treatment using naphtha in pentane (naphtha/C₅) blends and 1 h gravity settling. The transition region ranges from 15 to 40 vol % naphtha/C₅ for sample A (top) and from 20 to 50 vol % naphtha/C₅ for sample B (bottom).

FIG. 8 graphically depicts solids content in the top, middle and bottom settling levels (FIG. 3b) of the overflow (diluted bitumen oil product) after froth treatment using naphtha in pentane (naphtha/C₅) blends and 1 h gravity settling. The transition region ranges from 15 to 40 vol % naphtha/C₅ for sample A (top) and from 20 to 50 vol % naphtha/C₅ for sample B (bottom).

FIG. 9 depicts photographic images of bitumen extracted from original froth feed at ≈17.6 wt % asphaltenes (left) and from PFT underflow with pure C₅ at ≈51 wt % asphaltenes (right).

FIG. 10 graphically depicts asphaltene content in the overflow solvent-free bitumen, after 1 h of gravitational settling for samples A and B, expressed with respect to vol % naphtha/C₅ (top), total aromatic content wt % (middle) and total paraffinic content wt % (bottom). The asphaltene content in the initial bitumen froth (Table 1) is shown as a dashed line for reference.

FIG. 11 graphically depicts asphaltene content in the underflow (solvent-free bitumen in froth tailings) after 1 h of gravitational settling for samples A and B, expressed with respect to vol % naphtha/C₅ (top), total aromatic content wt % (middle) and total paraffinic content wt % (bottom). The asphaltene content in the initial bitumen froth (Table 1) is shown as a dashed line for reference.

FIG. 12 graphically depicts total paraffinic (green) and total aromatic (red) content in the naphtha/n-pentane solvent blends.

FIG. 13 shows a) Thin liquid film in water-in-oil emulsion with a highlighted (zoomed-in) oil contact zone between adjacent water droplets; b) Schematic of thin liquid film technique in a Scheludko-Exerowa cell [33] for model experiments of thin liquid films.

FIG. 14 Left: Gravity settling profiles of bitumen froth blended with solvents with total paraffinic contents from 52 to 100 wt %; Right: Schematic of the froth treatment settling vessel with interface locations at times 0 and 1 hour.

FIG. 15 graphically depicts water and solids content in overflow and asphaltene content in underflow (solvent-free bitumen in tailings), as a function of the total parraffinic content in naphtha/n-pentane blends. The transition region between paraffinic and naphthenic froth treatment behaviors is highlighted, as determined in Example 1.

FIG. 16 depicts optical microscopy images of bitumen produced fluid treated with naphtha collected approximately 8 hours after sampling from a production plant, intended to separate an oil from water phase by coalescence: (a)×250 magnification with areas of coalescence labeled as A-F; (b)×1000 magnification of the black rectangle area in (a) with a focus on bridging droplets; (c) zoomed image of the black rectangle area in (b); (d)×1000 magnification of the black rectangle area in (a) with a focus on the water droplets internal substance.

FIG. 17 shows the evolution of a thin liquid film at conditions below critical dilution (Athabasca bitumen dissolved in toluene) at S/B ratio of 1.6:(a) early stages of film drainage; (b) intermediate stage of film drainage show hydrodynamic channels due to dimple draining into the film meniscus; (c) stable plane parallel film at equilibrium with homogeneous thickness.

FIG. 18 shows the evolution of a thin liquid film at conditions above critical dilution (Athabasca bitumen dissolved in pure heptane at S/B ratio of 3):(a) early stages of film drainage with a small dimple in the centre and nm-sized asphaltene aggregates visible in the film; (b) development of a colorful pattern around the asphaltene aggregates; (c) transitioning to a gel-like continuous oil phase occupying the contact zone, visible as a film with a heterogeneous thickness profile.

FIG. 19 schematically depicts progression from fluid-like to oil gel-like behaviors, initiated by the surface asphaltene precipitation in the oil-water interface in the contact zone. Black spots denote surface asphaltene aggregates; dark grey dots and mesh denote oil gel-like formations.

FIG. 20 provides a graphical representation of the proposed mechanistic distinction of bitumen froth treatment in the transition region in comparison with the naphthenic froth treatment (NFT) and paraffinic froth treatment (PFT). Overflow (light and dark beige for low and high asphaltene content, respectively): water droplets (blue), mineral solid particles (yellow), bulk asphaltene precipitates (black), oil gel-like formations bridging between water and solids (brown), in PFT lighter beige represents partially deasphalted overflow than in NFT and Transition Region; Tailings: amorphous and gel-like tailings with a low hydrocarbon content (light brown); cake-like tailings with a higher hydrocarbon content (dark brown).

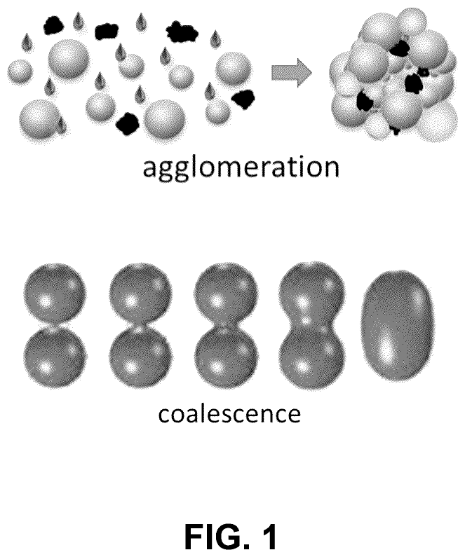

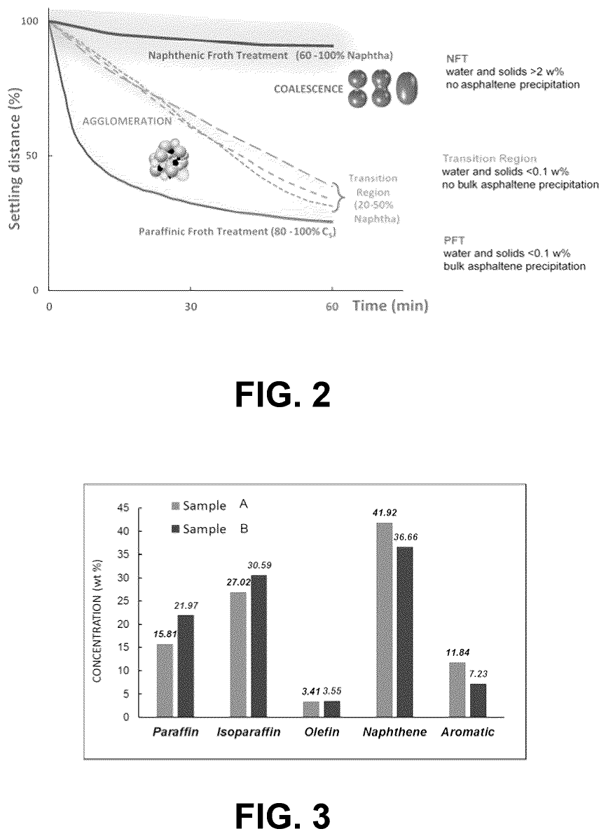

### DETAILED DESCRIPTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

Bitumen froth treatment is an important process step of bitumen recovery from oil sands by surface mining. In bitumen froth treatment, water and mineral solids are separated from the target organic bitumen product by using hydrocarbon solvents to generate a diluted bitumen product suitable for downstream use.

The term “diluted bitumen” is used herein to reference bitumen that is diluted with hydrocarbon solvent. This is the typical product obtained from commercial oil recovery processes that is accepted from the pipeline for downstream operations. Bitumen density and viscosity are very high and, consequently, bitumen is unsuitable for downstream use. The presence of hydrocarbon solvent (by addition or from upstream processing) is required to provide acceptable flow. The solvent content of the diluted bitumen can be adjusted to meet pipeline specification windows regarding required viscosity and/or specific gravity.

Residual water and mineral solids in diluted bitumen are detrimental to pipeline transport and downstream processes. Currently, two distinct commercial bitumen froth treatment processes (i.e., naphthenic and paraffinic) proceed via the oil-water separation mechanisms of coalescence and agglomeration, respectively, as a result of the solvent composition employed. The process of the present application is based on the existence of a transition region at ambient conditions and solvent-to-bitumen ratio of from 1 to 1.6, where not only coalescence is inhibited and agglomeration is initiated but also asphaltene is retained in the diluted bitumen product, which is demonstrated here for the first time.

The present inventors have now found that by employing conditions in the transition region, the advantages of the two commercial froth treatment processes can be combined and the drawbacks essentially eliminated. The diluted bitumen product obtained in the transition region is virtually free from residual water and solids (<0.1 wt %), using gravity settling alone, as in the paraffinic process, and the asphaltene is retained in it, as in the naphthenic process. The transition region range is determined to reside between 2.2-4.5 (±0.2) wt % aromatic, or 70-80 (±10) wt % paraffinic, content in the solvent. Bitumen froth treatment in this transition region facilitates the recovery of a sufficient amount of oil product with gravity settling alone. The present process aims to utilize the spontaneous agglomeration mechanism in the transition region, instead of suppressing it. This approach can be used not only for bitumen froth treatment but also for other agglomeration-based oil-water separation processes for obtaining bitumen from a bitumen-containing mixture, such as in situ bitumen recovery.

The present application provides a method for obtaining diluted bitumen from bitumen-containing mixtures, such as bitumen froth (e.g., a bitumen froth treatment process), that combines the advantages and eliminates the drawbacks of NFT and PFT, and has a decreased environmental impact. The method makes use of a transition region that exists between NFT and PFT, in terms of solvent composition, where bitumen froth treatment can be conducted using a spontaneous agglomeration mechanism, without noticeable bulk asphaltene precipitation. To proceed “without noticeable bulk asphaltene precipitation” means that the amount of asphaltene in the starting product is essentially the same as in the diluted bitumen product.

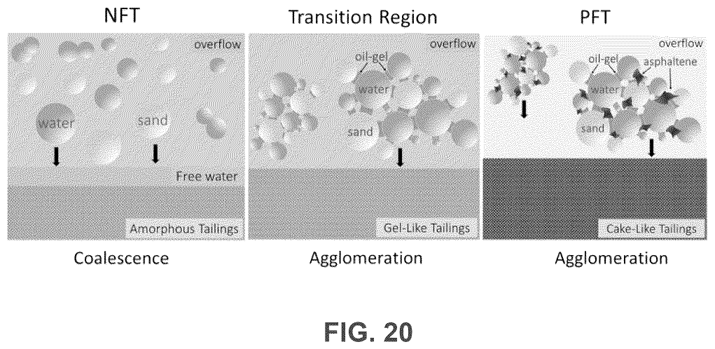

In the transition region, the system spontaneously forms agglomerates of water and mineral solids promoted by surface asphaltene precipitation, while the S/B ratio and solvent composition does not support bulk asphaltene precipitation. The surface asphaltene precipitation is defined as the occurrence of nanosize asphaltene aggregates at the oil-water interface. (see Example 2) This is illustrated graphically in FIG. 20.

A method for separating diluted bitumen, for example in bitumen froth treatment, as described herein is considered effective at a given solvent composition when the oil product meets all of the following benchmarks: i) less than 0.1 wt % water in the oil product; ii) less than 0.1 wt % solids in the oil product; and iii) same asphaltene content as the froth feed (within ±3 wt %), for example, as determined by analyzing for n-pentane-insoluble asphaltene content in solvent-free material. An example of a suitable method for determining asphaltene content is provided in reference 34.

In one embodiment, there is provided a method for producing diluted bitumen from a bitumen-containing mixture, e.g., bitumen froth, which is a mixture comprising the bitumen, water and mineral solids (for example, as defined in the Background). The method includes the steps of: (a) combining the mixture with a solvent blend to obtain a combination having a ratio of the solvent blend to the bitumen that is below the critical dilution of asphaltene precipitation, for example, a ratio of about 1.0 to about 1.6 by mass, wherein the solvent blend comprises aromatic solvent and from 70-80 (±10) wt % paraffinic solvent; (b) mixing the combination; and (c) separating the diluted bitumen from the water and mineral solids. In some embodiments, the aromatic solvent content in the solvent blend is from 2.2-4.5 (±0.2) wt %. Other factors, such as the contributions of naphthenes or specific aromatics present in the bitumen-containing mixture or the solvent blend can potentially influence the transition region range in different samples.

The term “critical dilution” is used herein to reference the dilution ratio that coincides with the onset of bulk asphaltene precipitation. The critical dilution will vary depending on solvent composition.

Solvent Blend

The method described herein makes use of a solvent blend that functions to provide the density difference and separate the diluted bitumen product by gravity from the residual water and solids in the bitumen-containing mixture (e.g., bitumen froth), by inhibiting coalescence and initiating agglomeration of residual water and solids in bitumen froth treatment.

The solvent blend comprises a mixture of aromatic components and paraffinic components, such that the paraffinic components are present in an amount of from about 60 to about 90 wt %. The contributions of naphthenes can potentially influence the transition region range in terms of the composition of the solvent blend. In some embodiments, the aromatic components are present in the solvent blend in an amount of from about 2.0 to about 4.7 wt %.

In some embodiments, the solvent blend is a mixture of one or more aromatic compounds and one or more paraffinic compounds. The solvent blend can be prepared by simply mixing the one or more aromatic compounds with the one or more paraffinic compounds.

In another embodiment, the solvent blend comprises gas condensate (e.g., natural gas condensate) at a source of the paraffinic compounds. Typically, gas condensates predominantly comprise a mixture of light paraffin and isoparafin (C₃-C₁₀, or C₃-C₈, alkanes), with higher alkanes also present but at lower relative amounts. Pentane is usually the most predominant alkane present in gas condensates (typically, in the amount of about 40 wt %), which is why it was used as a model paraffinic solvent in the Examples that follow.

In other embodiments, the solvent blend comprises naphtha. The naphtha may be a conveniently available naphtha, such as a refinery product or feedstock, or obtained from a bitumen upgrading process). Naphthas from different sources will vary in aromatic and paraffinic content. Accordingly, it can be beneficial to analyze the naphtha prior to use to determine aromatic content to determine whether additional aromatics should be added to the solvent blend or if paraffinic compounds need to be added to reach the required amount of aromatic and paraffinic components in the solvent blend. Typically, commercial naphtha will contain paraffinic, isoparaffinic, olefinic, aromatic and naphthenic components. The typical aromatics are xylene and toluene with additional smaller amounts of benzene and/or ethylbenzene (as shown in the PIona results in FIG. 3).

Irrespective of whether naphtha is used in the solvent blend, the amount of aromatic compounds present will be in the range of from about 2.0 to about 4.7 wt % based on the total weight of the solvent blend. The contributions of naphthenes can also potentially influence the solubility of asphaltenes and the transition region range in terms of the composition of naphtha.

In both embodiments, the paraffinic compounds are saturated hydrocarbons, such as straight or branched alkanes. For example, the paraffinic compounds can be selected from straight or branched C₃ to C₁₀ alkanes. In one example, the paraffinic compounds comprise or consist of n-pentane (C₅ alkane). The one or more paraffinic compounds are mixed with the aromatic compounds and/or the naphtha to bring the total amount of paraffinic compounds present in the solvent blend to an amount of from about 60 to about 90 wt %.

Mixing with the Solvent Blend

In the method of the present application a mixture comprising bitumen, (e.g., bitumen froth) is combined with the above-described solvent blend and mixed. The mixing conditions can vary, for example, depending on the input bitumen-containing mixture and the volumes employed. In particular, the mixing system, mixing time, mixing speed, and temperature can be varied depending on the particular circumstances.

In some embodiments, the mixing step is performed using a closed mixing, batch setup that minimizes solvent loss. The lab scale batch mixing system employed in the following Examples provides information and parameters that can be used to scale up the process in a variety of commercial PFT settlers. In commercial use, the method of the present application would typically be performed as a continuous process. For such a continuous process, PFT settlers would be suitable for use. However, it would be well understood by the skilled person that other settlers or continuous gravity separation systems can be used in performing the presently described method.

In some embodiments, the mixing is performed using a mixing system with a marine impeller and baffler. The mixing speed can be about 600 RPM.

The mixture with the solvent blend is made such that the ratio of the solvent to bitumen is about 1.0-1.6 by mass. At this ratio, the mixture is below the critical dilution of asphaltene precipitation, to avoid bulk asphaltene precipitation.

In some embodiments, mixing of the solvent blend with the bitumen-containing mixture (e.g., bitumen froth) is performed for about 15 minutes to about 1 hour under ambient temperature and pressure. However, the mixing conditions can be adapted to the geometry, temperature and pressure of the commercial settlers (e.g., PFT settlers). Selection of the mixing conditions would be a matter of routine for the skilled person.

Separation

Following sufficient mixing of the bitumen-containing mixture (e.g., bitumen froth) with the solvent blend, the diluted bitumen is separated from the mixture. In some embodiments, the separation comprises first allowing the mixture to separate into diluted bitumen product as the overflow layer by gravity settling. The method described herein avoids the need for costly and energy intensive separation processes such as centrifugation. The diluted bitumen overflow product will be collected from the top of the commercial settlers and the froth treatment tailings, containing the residual water and mineral solids are collected from the bottom.

The method described herein can be particularly useful for bitumen froth treatment. However, it should be understood that it is not limited to use in treatment of bitumen froth.

To gain a better understanding of the invention described herein, the following examples are set forth. It should be understood that these examples are for illustrative purposes only. Therefore, they should not limit the scope of this invention in any way.

### EXAMPLES

### Example 1: Bitumen Froth Treatment

Materials and Methods

Materials

Two separate pairs of samples, referred to herein as naphtha A and bitumen froth A as well as naphtha B and bitumen froth B were used to perform bitumen froth treatment experiments. The naphtha A and bitumen froth A were provided by CanmetENERGY Devon. The naphtha B (diluent feed to secondary extraction) and bitumen froth B were obtained from the Base Plant operation of Suncor Energy in Alberta. The bitumen froth samples were stored at room temperature in sealed containers to prevent water evaporation. The bitumen froth was re-homogenized at ≈50° C. and subsampled prior to each experimental run to ensure the uniform and consistent distribution of froth components.

Naphtha samples were analyzed by the gas chromatographic PIONA (Paraffins, Isoparaffins, Olefins, Naphthenes and Aromatics) method conducted using Agilent 7890™ with vacuum ultraviolet detector (GC-VUV Analytics, Inc., Austin TX, USA) to determine the hydrocarbon composition and aromatic contents (FIG. 3) The total aromatic (paraffinic) contents of naphtha A and B were 11.84 wt % (42.8 wt %) and 7.23 wt % (52.6 wt %), respectively. The aromatic content was mainly xylene and toluene, and to a lesser extent benzene and ethylbenzene in both naphtha A and B.

The compositions of the two bitumen froth samples, determined by Dean-Stark analysis, are listed in Table 1. The compositions of froth A and B in terms of water, solids, bitumen and asphaltene contents are similar. Both froth samples are representative of commonly produced bitumen froth.

TABLE 1
Composition of bitumen froth samples A and B.

| Content, wt % | Sample A | Sample B |
|---|---|---|
| Water | 25.7 | 23.8 |
| Solids | 12.6 | 12.8 |
| Bitumen | 61.7 | 63.4 |
| Asphaltenes* | 17.7 | 17.5 |

*Asphaltenes are reported as wt % of the bitumen fraction

Experimental Conditions and Methods

The froth treatment was conducted at an S/B ratio of 1.6 by volume using a set of solvent blends of naphtha with lab-grade n-pentane (C₅) ranging from 0 to 100 vol % naphtha/C₅ at 5, 10 or 20 vol % increments. The densities of the naphtha/C₅ blends were determined using Anton Paar™ DMA 4500 densitometer at 25° C.

The mixing of bitumen froth and solvent was performed using a 1-L, closed mixing batch setup, custom-designed to assure optimal mixing conditions for froth treatment and to prevent solvent loss. The experimental conditions, mixing system, mixing time, mixing speed, and S/B ratio (Table 2) were selected based upon experimental protocols developed in-house and historical data collected in CanmetENERGY Devon. [11,36] The retention of light-ends was validated by performing a mass balance assessment after the completion of each experiment.

TABLE 2
Experimental conditions for bitumen froth treatment.
Gravity Settling Conditions

| | | |
|---|---|---|
| Mixing time | 15 | minutes |
| Settling time | 60 | minutes |
| Mixing speed | 600 | RPM |

| | |
|---|---|
| Mixing system | Marine impeller and baffler |
| Solvent | Naphtha/Pentane mixture |
| S/B ratio | 1.6 |
| T and P | 22 C.; Atmospheric |
| Naphtha/C5 ratio | 0 to 100 vol % |

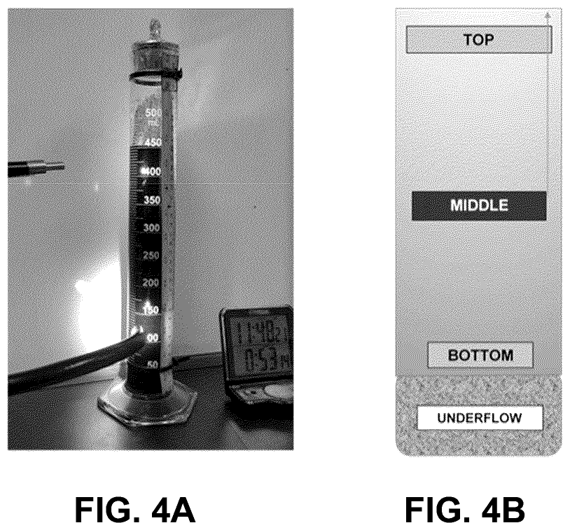

Immediately after the mixing for 15 minutes, the diluted froth was transferred to a graduated cylinder for settling. The gravity settling setup (FIG. 4) consisting of a 500-mL graduated cylinder and fibre-optic illumination, was used to visually track the settling interface. The level of the interface was recorded at 30 second intervals.

After 1 hour of settling, the graduated cylinder was divided into four subsampling zones, referred to as the top, middle and bottom levels of the overflow (i.e., diluted bitumen product), and the underflow (i.e., tailings), as labeled in FIG. 4b, the subsamples were obtained starting from the top of the vessel using a volumetric pipette. Analysis of the water and solids content of the overflow was performed immediately after subsampling to avoid any effects from additional separation over time. The subsampling procedure and subsample analyses are described in Table 3 and Table 4, respectively.

TABLE 3
Subsampling procedure referring to the levels labeled in FIG. 4b.

| Level | Subsampling Procedure | Notes |
|---|---|---|
| Top | 0.5 cm below liquid/air interface | — |
| Middle | Middle of overflow layer | The middle level sampling was |
| | | conducted at a distance consistent |
| | | with the upper interface at 60% of |
| | | the total settling distance (FIG. 4b) |
| Bottom | 1 cm above visual underflow | Special care was taken to not |
| | interface | disturb the underflow layer. |
| Underflow | Depending on tailings structure: | — |
| | “Cake-like” tailings were | — |
| | scooped with a spatula from the | |
| | middle of the cake | |
| | Amorphous tailings were | Solvent content variations may |
| | scooped in the viscous area | occur due to the nature of the |
| | away from the overflow residue | tailings |

TABLE 4
Analysis of subsamples obtained from the froth treatment overflow and underflow.

| Analysis Description | Analytical Method |
|---|---|
| Water content in overflow | Karl Fischer titration (V20 Mettler Toledo) |
| Water content in underflow | Dean-Stark analysis |
| Solids content in overflow at | High speed centrifugation (20,000 g), followed by |
| different levels of settling | vacuum filtration of the supernatant through 0.22 μm |
| | using solvent-resistant filter paper. All samples were |
| | dried in the oven at 80° C. for 30 minutes |
| Solids content in underflow | Dean-Stark analysis |
| Asphaltene content in overflow, | Rotary evaporation, C₅-precipitation/filtration |
| solvent-free bitumen | |
| Asphaltene content in underflow | High speed centrifugation (20,000 g) on the overflow |
| solvent-free bitumen from | to remove residual fine solids; Rotary evaporation to |
| tailings^{[a]}. | remove solvent from Dean-Stark toluene solution; |
| | determination of the n-pentane-insoluble asphaltene |
| | content on solvent-free bitumen by CanmetENERGY |
| | procedure [34] |
| Tailings and froth composition | Bitumen extraction from tailings by Dean-Stark; High |
| | speed centrifugation (20,000 g) to remove residual fine |
| | solids; Rotary evaporation to remove solvent; |
| | determination of the n-pentane-insoluble asphaltene |
| | content of the solvent-free bitumen by |
| | CanmetENERGY procedure |

^{[a]}The heavy ends of naphtha may remain in bitumen during rotary evaporation, causing an error of 0.5-1.0 wt % in the asphaltene content determination, which is below the experimental error of ± 3%.

Results and Discussion

The transition from coalescence to agglomeration was investigated by altering the paraffinic content of the solvent by blending C₅ with commercial naphtha (i.e., solvent with a predetermined aromatic and paraffinic content) from 0 to 100 vol % naphtha/C₅ The selected constant S/B ratio of 1.6 is reported in the PFT literature as the “optimal” for massive bulk asphaltene precipitation [28,37]. Achieving no bulk asphaltene precipitation at this S/B ratio would be a clear indication of the existence of a transition region. Identifying a significantly wide solvent composition range is important to show that the transition region is wide enough for conducting bitumen froth treatment.

Effects of the Solvent Aromatic and Paraffinic Content on the Transition Region

The paraffinic content in solvent has been established to have a predominant effect on the asphaltene precipitation [4,11]. The paraffinic and aromatic contents of commercial naphtha may vary significantly and influence the asphaltene onset point [30,31,32].

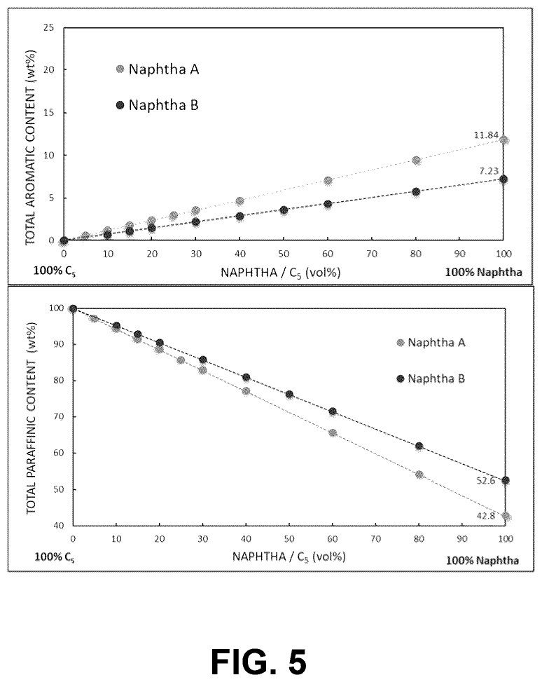

In FIG. 5 the solvent composition is presented in terms of total aromatic and total paraffinic contents in the solvent blends. Considering the close similarity of the two froth samples (Table 1), the differences in behavior between samples A and B may be attributed predominantly to the difference in the naphtha composition, as the aromatic contents of naphtha A (11.84 vol %) is 1.6 times higher than that of naphtha B (7.23 vol %).

Settling Behavior of Dilutee Bitumen Froth Upon Treatment

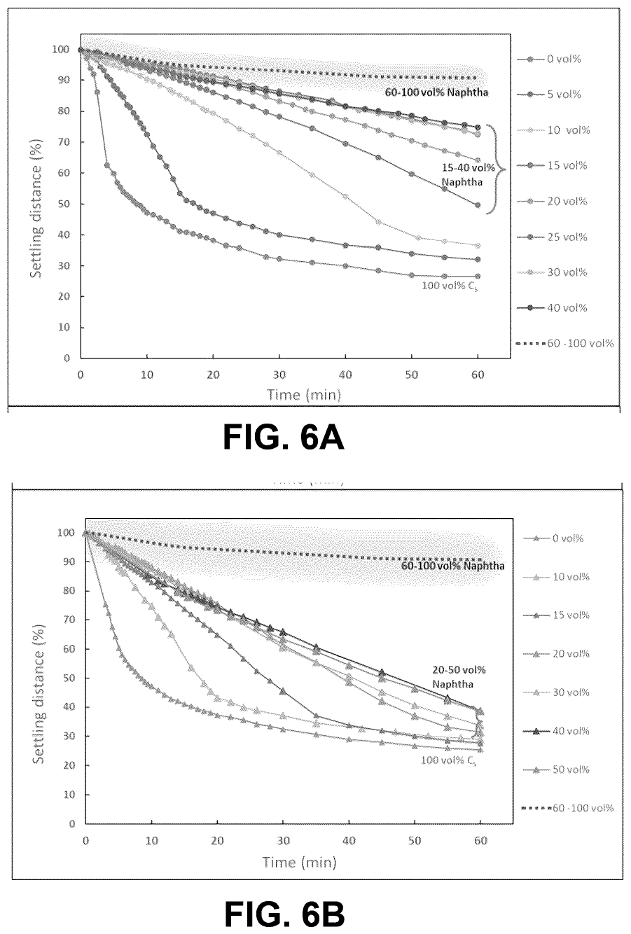

The results of the settling behavior of treated froths A and B with respect to variations in the solvent naphtha/C₅ blending are presented in FIG. 6. The settling interface level from the top of the settling vessel, expressed as a percentage of the total sample height (FIG. 4) is plotted with respect to the settling time. The settling behavior of the two froth samples was comparable, albeit with some notable differences in the amount of product obtained after settling. Three distinct behaviours, Fast Initial Settling; No Visual Settling and Gradual Linear Settling were identified in both samples

The Fast Initial Settling in the settling profiles was observed at 0-10 vol % and 0-15 vol % naphtha/C₅ for samples A and B, respectively and is representative of PFT [11,38] behavior, based on agglomeration as an oil-water separation mechanism. In this scenario, fast settling in the initial time of 10 minutes or less occurred and a “slow” gradual setting behaviour after that. The fast settling is due to the incorporation of the aggregates into a cake-like structure that settles as one layer and visually appears as a clearly distinguished settling interface. The No Visual Settling, at 60-100 vol % naphtha/C₅ is representative of NFT, based on coalescence [8,17]. In these instances, loose, amorphous tailings were observed at the bottom of the vessel and visual upper settling interface was absent. The absence of a distinguishable settling interface was due to residual individual water droplets and solids that had not coalesced during the mixing stage and could not settle under gravity for the given time of 1 h. The differences in settling behavior due to naphtha content variations, combined with the visually observed “cake”-like and amorphous underflow reflect significant changes in the aggregation ability, size, shape and extent of bonding, and are indicative of a change in the oil-water-solids separation mechanism from agglomeration to coalescence. The Gradual Linear Settling behaviour at intermediate naphtha content (15-50 vol % naphtha/C₅, FIG. 6) is identified as transitional between the Fast Initial Settling at low naphtha content, as in PFT, and No Visual Settling at high naphtha content, as in NFT.

It is also important to consider the settling behavior in terms of the overflow product volumes obtained during the froth treatment. In the Gradual Linear Settling range, the overflow product volume of 25-50% of the total volume for sample A (FIG. 6A, top) was significantly less than that in the Fast Initial Settling range, where the interface settles to 50-75% of the total volume. For sample B (FIG. 6B, bottom), the overflow product was 62-67% of the total volume, which is significantly more in comparison with sample A. The overflow product amount obtained in Gradual Linear Settling for sample B was very close to that obtained by Fast Initial Settling. These results demonstrate effectiveness of the method due to the fact that the sample B froth in the transitional Gradual Linear Settling behaviour delivers a sufficient amount of bitumen product by gravity settling alone. Without wishing to be bound by theory, the difference in the amount of product obtained in 1 hour between the two samples could be related to differences in the paraffinic and aromatic content of naphtha, which may influence the asphaltene aggregation propensity, shape and size, and lead to settling behaviour differences. Other factors, such as mixing geometry, rate and volume variations, can also be contributing factors.

Residual Water and Solids Content in Overflow

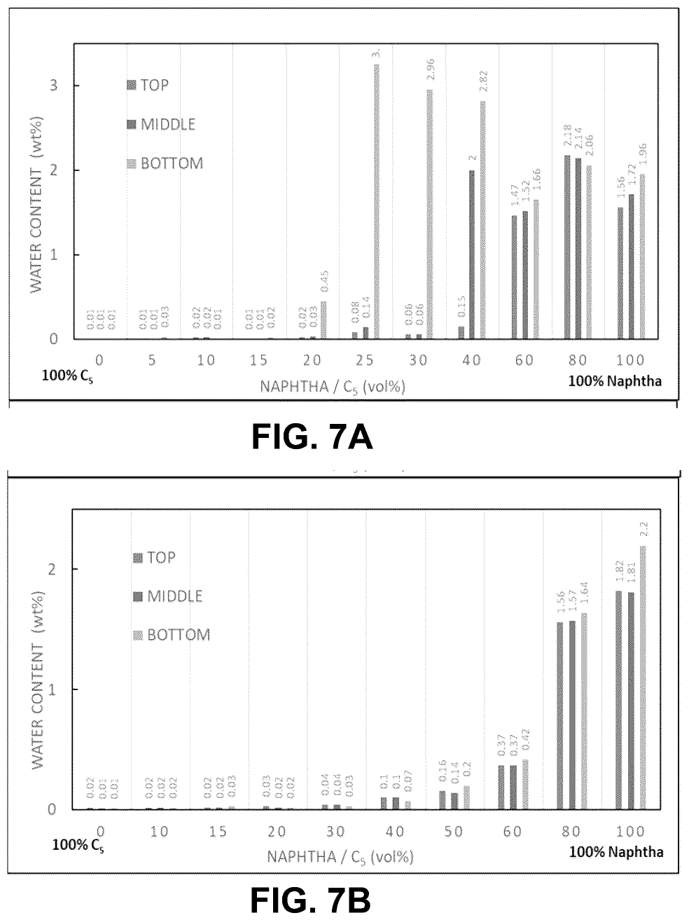

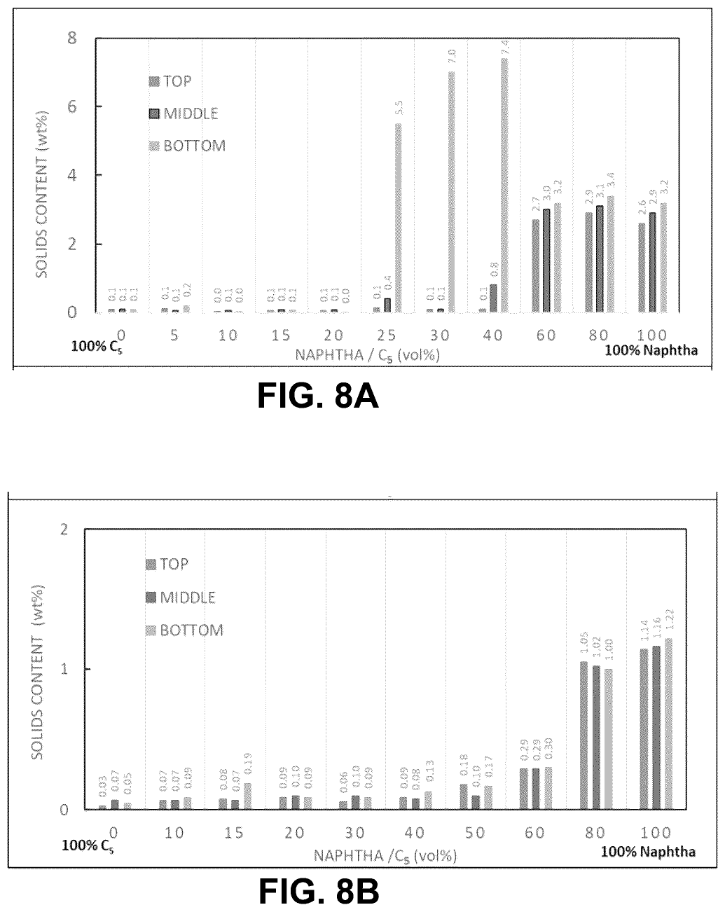

The extent of residual water and solids removal from the overflow (diluted bitumen product), determined at the top, middle and bottom levels (FIG. 3b), is presented in FIG. 7 and FIG. 8. At the intermediate naphtha content of 20-40 vol % naphtha/C₅ for sample A and 20-50 vol % naphtha/C₅ for sample B, the residual water and solids content in the top and middle sampling levels are below 0.1 wt %. The water and solids removal values in the intermediate naphtha content region are also comparable with those in the low naphtha content region, as in PFT. These results allow for the definition of the transition region at an intermediate naphtha content, where the oil product quality benchmarks i) and ii) pertaining to the residual water and solids content in the oil product are met, and the separation is characterized by the Gradual Linear Settling behaviour (FIG. 6).

At low naphtha content, the cake-like formation of the settling interface is associated with the spontaneous agglomeration mechanism, representative of the Fast Initial Settling behavior. In these conditions, the water droplets and solids are trapped in aggregates large enough to complete the settling for the given time of 1 hour, delivering a clean, high quality product, free from residual water and solids. Therefore, no vertical distribution of the water content among the top, middle and bottom sampling levels in the overflow, defined in FIG. 4b, was observed. At high naphtha content, the No Visual Settling behavior is associated with the oil-water separation mechanism of coalescence, where a loose amorphous tailings, without strongly-bonded aggregates, was observed. The variation in residual individual water droplet/particle sizes in the overflow results in a vertical distribution, as only droplets or particles that are large enough, following the Stokes Law, would settle in the given time of 1 hour and the fine droplets and particles would remain in the overflow. Hence, with gravity settling alone, without the assistance of centrifugation or additives to facilitate the oil-water separation, coalescence alone does not deliver an oil product of sufficient quality.

Asphaltene Distribution

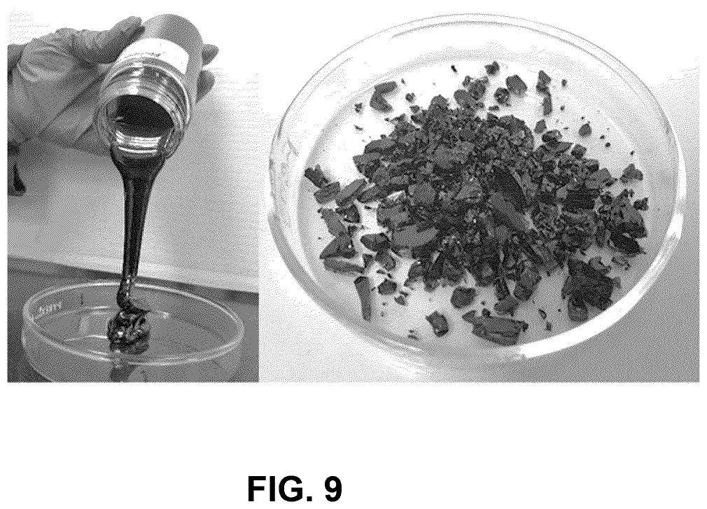

In FIG. 9, images are provided showing the appearance of solvent-free, desolidified and dewatered bitumen samples containing ˜17.6 wt % asphaltenes obtained from the original froth feed (left) and obtained from PFT underflow using 100% C₅ (right) containing ≈51 wt % asphaltenes. The high asphaltene content of the PFT underflow resulted in a crystallite-like appearance, whereas the bitumen from the original froth feed was a liquid.

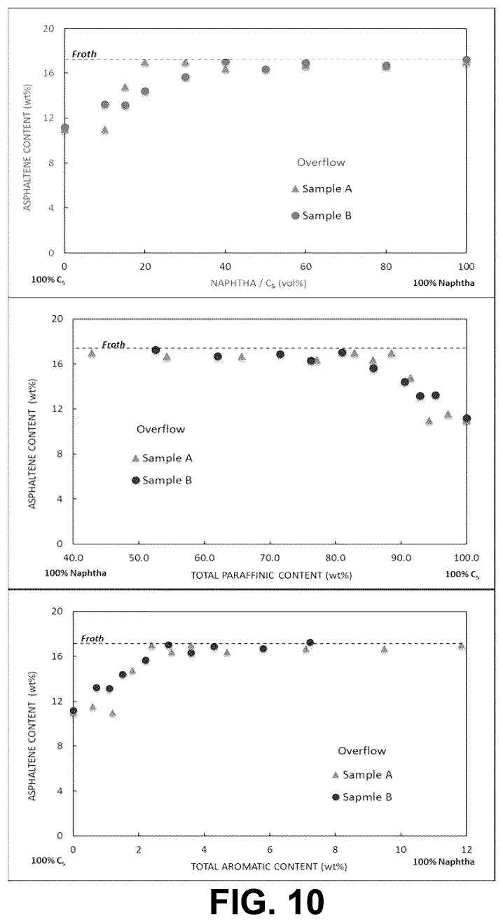

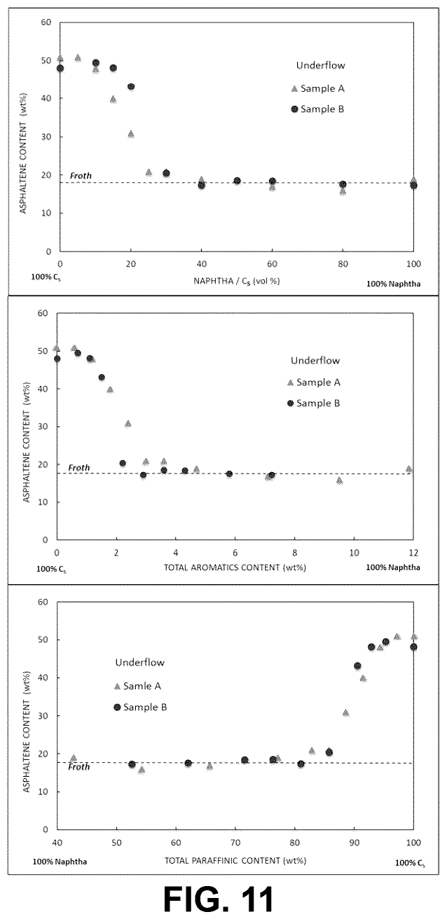

In order to fully define the transition region, froth treatment is required to not cause bulk asphaltene precipitation, while sufficiently removing both residual water and solids from the overflow. The asphaltene content in froth treatment oil product (overflow) and the tailings (underflow) was analyzed with respect to the solvent-free bitumen, and compared with that in the original froth feed. In FIG. 10 and FIG. 11 the asphaltene content in the solvent-free bitumen from the froth treatment overflow and underflow, respectively, are presented relative to vol % naphtha/C₅ (top graphs), wt % total aromatic content (middle graphs) and wt % total paraffinic content (bottom graphs). The low naphtha content range (0-20 vol % naphtha/C₅) contains partially-deasphalted oil product (as low as 11 wt % of asphaltenes for pure C₅) and underflow tailings with high asphaltene content (as high as 51 wt % for pure C₅). The notable differences between samples A and B with respect to the naphtha/C₅ contents (top graphs) are attributed mainly to the variations in the aromatics (11.84 wt % for sample A and 7.23 wt % for sample B) and paraffinic content (42.8 wt % for sample A and 52.6 wt % for sample B). An improved agreement between samples A and B was achieved by presenting the results with respect to the total aromatic and paraffinic contents.

Therefore, the differences between sample A and B can be attributed largely to the effect of the paraffinic and aromatic contents on asphaltene precipitation.

As the naphtha content in the solvent blends is increased, the asphaltene content in the oil product increases and that in the underflow tailings decreases (FIG. 10 and FIG. 11). In the intermediate and high naphtha content range from 20 to 100 vol % naphtha/C₅, the asphaltene content in the overflow and underflow is comparable with that of the original bitumen froth feed, within the experimental error of ±3 wt %.

These results confirm that bulk asphaltene precipitation does not occur in the intermediate and high naphtha content range and therefore meet benchmark iii). Moreover, the asphaltene retention occurs in the same intermediate naphtha content region, where the residual water (<0.1 wt % FIG. 7) and solids (<0.1 wt % FIG. 7) contents meet benchmarks i) and ii), and Linear Gradual Settling behavior is identified (FIG. 4). Therefore, in the intermediate naphtha region the oil product quality meets the transition region benchmarks i)-iii) simultaneously, where the water and solids are effectively removed without a notable bulk asphaltene precipitation.

Transition Region Operational Window

The operational window for the froth treatment can be established using a side by side comparison of the hypothesis benchmark results presented in Table 5, where the transition region is highlighted in bold-italic font as the conditions with residual water and solids contents of less than 0.1(±0.05) wt %, without bulk asphaltene precipitation. This approach allows definition of the “win-win” coalescence-agglomeration transition region in terms of naphtha, total aromatic, and total paraffinic contents at an S/B ratio of 1.6 and ambient conditions. The transition region's lower and upper limits are determined based on the thresholds characteristic of the PFT for asphaltene retention and NFT for water and solids removal, respectively. The lower limit of the transition region is at approximately 2.2(±0.2) wt % total aromatic content, which corresponds to approximately 20 vol % and 30 vol % naphtha/C₅ for samples A and B, respectively. The upper limit of the transition region is at approximately 4.5(±0.2) wt % total aromatic content, which corresponds to approximately 40 vol % and near 60 vol % naphtha/C₅ for sample A and B, respectively. In terms of the total paraffinic contents, the transition region range is at 72-89(±3) wt %. Other factors, such as the contributions of naphthenes or specific aromatics, for example, benzene, toluene and xylenes, or ratios among these, could also potentially influence the transition region definition in different samples.

TABLE 5
Residual water and solids, and asphaltene content in the overflow (OF) and underflow (UF) with the
transition region highlighted in bold-italic font for sample A and in parentheses for sample B.

| Naphtha/C₅ | Aromatic (wt %) | | Paraffinic (wt %) | | Water | | Solids | | Asphaltenes | Asphaltenes |
|---|---|---|---|---|---|---|---|---|---|---|
| (vol %) | Sample A | Sample B | Sample A | Sample B | (wt %) OF | | (wt %) OF | | OF (wt %) | UF (wt %) |
| 0 | 0 | 0 | 100.0 | 100.0 | 0.01 | (0.01) | 0.09 | (0.05) | 11 (11) | 51 (48) |
| 5 | 0.6 | ^{[a]} | 97.1 | ^{[a]} | 0.01 | (0.01) | 0.12 | (0.12) | 12 (12) | 51 (51) |
| 10 | 1.2 | 0.7 | 94.3 | 95.3 | 0.02 | (0.02) | 0.05 | (0.07) | 11 (13) | 48 (49) |
| 15 | 1.8 | 1.1 | 91.4 | 92.9 | 0.03 | (0.03) | 0.07 | (0.08) | 15 (13) | 40 (48) |
| 20 | [symbol] | 1.5 | 88.6 | 90.5 | [symbol] | | [symbol] | | [symbol] | [symbol] |
| 25 | [symbol] | ^{[a]} | 85.7 | ^{[a]} | [symbol] | | [symbol] | | [symbol] | [symbol] |
| 30 | [symbol] | [symbol] | 82.8 | 85.8 | [symbol] | | [symbol] | | [symbol] | [symbol] |
| 40 | [symbol] | [symbol] | 77.1 | 81.0 | [symbol] | | [symbol] | | [symbol] | [symbol] |
| 50 | ^{[b]} | [symbol] | ^{[b]} | 76.3 | [symbol] | | [symbol] | | [symbol] | [symbol] |
| 60 | 7.1 | [symbol] | 65.7 | 71.5 | [symbol] | | [symbol] | | [symbol] | [symbol] |
| 80 | 9.5 | 5.8 | 54.3 | 62.0 | ≈2-3 | (1.60) | 3.3 | (1.00) | 17 (17) | 16 (17) |
| 100 | 11.84 | 7.23 | 42.8 | 52.6 | ≈2-3 | (1.80) | — | (1.20) | 17 (17) | 19 (17) |

^{[a]} The 5 and 25 vol % naphtha/C₅ treatments were conducted only for sample A;
^{[b]} The 50 vol % naphtha/C₅ treatment was conducted only for sample B.

Conclusions

The present example has demonstrated, at ambient conditions, the existence of a “win-win” zone or a transition region between NFT and PFT in terms of naphtha, paraffinic and aromatic content at the constant S/B ratio of 1.6, reported as “optimal” for asphaltene precipitation in PFT. The transition region is associated with the change of the water-oil separation mechanism from coalescence to agglomeration. The advantages of conducting froth treatment in the transition region are the near complete water and solids removal from the oil product without the occurrence of bulk asphaltenes precipitation (i.e., without hydrocarbon product loss).

This was demonstrated by performing a series of bench-scale bitumen froth treatment experiments at room temperature using two froth and naphtha samples with similar froth compositions but substantially different naphtha compositions. The oil product quality is ascribed to the transition region, when the residual water and solids contents in the overflow oil product are less than 0.1 wt %, using gravity settling alone, and the asphaltene content is comparable with that in the original froth feed.

The intermediate naphtha content region of 20-50(±10) vol % naphtha/C₅ is defined as the transition region, which also corresponds to 2.2-4.5 (±0.2) wt % aromatic or 70-80 (±10) wt % paraffinic contents in the solvent. In the conditions of the transition region, the water and solids are removed to an extent comparable to that achieved in PFT, and the asphaltenes are retained in the oil product, as in NFT. In the transition region, the froth treatment settling profiles are identified as Gradual Linear Settling, intermediate between PFT and NFT. The amount of overflow obtained in the transition range suggests that a sufficient amount of oil product can be delivered, as in PFT, with gravity settling alone. Considering that the experiments were performed at the solvent-to-bitumen S/B ratio of 1.6, optimal for bulk asphaltene precipitation in PFT, the delivery of an oil product without bulk asphaltene precipitation is an important scientific advancement. The findings demonstrate that the spontaneous agglomeration mechanism in the transition region can be used as an advantage to deliver a high quality oil product, virtually free of residual water and solids and with asphaltene retention, instead of an issue diminishing the separation efficiency.

### Example 2: Coalescence Inhibition and Agglomeration Initiation Near the Critical Dilution of Asphaltene Precipitation

In bitumen recovery from oil sands, solvent addition is used to destabilize the water-in-diluted bitumen emulsions and separate the valuable oil product from water and solids. For each solvent, a critical solvent-to-bitumen ratio or “critical dilution” can be determined that coincides with the onset of bulk asphaltene precipitation, at which the system properties change abruptly. Above the critical dilution, solvent addition promotes bulk asphaltene precipitation and separation by the agglomeration of water droplets, solids and precipitated asphaltenes. Below the critical dilution, separation occurs by the coalescence of water droplets. The properties of the water-diluted bitumen interface may be key to improving the mechanistic understanding of water-in-diluted bitumen emulsions and bitumen recovery. In the present example, the behavior of water-in-diluted bitumen emulsions is explored at macro- and microscopic scales and provides novel insights at conditions below critical dilution. Bench scale bitumen froth treatment settling experiments demonstrate the ability to attain effective water and solids separation based on agglomeration, without any noticeable bulk asphaltene precipitation. Light microscopy images reveal the inhibition of water droplet coalescence and the initiation of agglomeration due to the transformation of the oil continuous phase into a gel-like structure in the contact zone between water droplets. Thin liquid film observations show drastic changes in the continuous oil phase properties in the contact zone between water droplets at similar conditions that are attributed to the formation of both asphaltene aggregates at the interface and an oil gel-like structure that expands around them. These findings lead to the proposal that agglomeration can occur below critical dilution by surface asphaltene precipitation at the water-oil interface, without bulk asphaltene precipitation. The multiscale insights highlight opportunities to improve further not only bitumen froth treatment but also other oil-water-solids separation process.

### INTRODUCTION

Delivering a high-quality oil product free from residual water and mineral solids is the main goal of the hydrocarbon recovery from Western Canada's vast oil sands reserves [2]. Residual water and mineral solids are detrimental to pipeline transport and downstream processes, such as upgrading and refining [9]. Deeply buried bitumen-rich oil sands deposits require in situ recovery processes, such as steam assisted gravity drainage (SAGD). Hydrocarbons are recovered from shallow deposits using surface mining warm water extraction [1], subsequently separated from the aqueous phase by a solvent addition process, known as bitumen froth treatment. The most widely used industrial-scale processes—naphthenic froth treatment (NFT) and paraffinic froth treatment (PFT), differ in the composition and amount of solvent added [2,9].

The primary oil-water separation mechanism in the majority of the oil sands recovery processes, including SAGD and NFT, relies on the coalescence of water droplets emulsified in oil and the formation of larger liquid domains. In oil recovery processes based on water or steam, the density difference between the oil phase (diluted bitumen) and water drives the vertical separation [6]. However, the oil-water separation by coalescence can be achieved only to a certain degree. In the coalescence-based NFT, the separation by gravity settling alone yields a diluted bitumen product with significant residual water (2-5 wt %) and solids (0.5-1 wt %) contents [7,8]. The bitumen product from NFT requires further treatment by centrifugation, chemical addition, and polishing steps to improve the oil product quality in order to meet downstream specifications [23,24,25,26], which leads to increased overall capital costs, energy use and processing time. Even with the additional steps, emulsified water remains in the product in the form of small 0.5-5 μm water droplets, lowering the oil product quality [18].

An alternative separation mechanism, based on the agglomeration and settling of water droplets and fine solids, is employed in the PFT process [12,13,14]. In PFT, the oil separation is facilitated by the partial (several wt %) precipitation of the asphaltene fraction of bitumen (also known as bulk asphaltene precipitation), which occurs at high paraffinic solvent content and solvent to bitumen (S/B) ratio. It is important to note that the asphaltene are not a specific family of chemical compounds with common functional groups but a solubility class, defined as the fraction of bitumen that is soluble in light aromatics, such as toluene, and insoluble in alkanes, such as pentane or heptane [2,39] and are not limited to a specific chemical [35,40]. At the unfavorable solubility conditions of PFT, the asphaltenes precipitate, forming a separate phase, and together with water droplets and solids spontaneously form large non-homogeneous clusters, referred to as agglomerates. The agglomerates settle rapidly under gravity, leaving a high-quality diluted bitumen product as a supernatant [38]. The PFT delivers a bitumen product nearly free (<0.1 wt %) from residual water and solids at the expense of an increased throughput and substantial hydrocarbon loss, compared to NFT [16]. The increased throughput is due to the S/B ratio of about 1.6 (compared to about 0.6 for NFT) that is needed to provide optimal conditions for bulk asphaltene precipitation [15,31,37]. The hydrocarbon loss due to asphaltene precipitation decreases product recovery and generates hydrocarbon-rich tailings [9,14]. It is evident that the choice between NFT and PFT presents the oil producers with different challenges, such as high residual water and solids content or loss of hydrocarbon product to the tailings [3,4]. These commercial froth treatment processes could not satisfy the optimal criteria of high recovery and oil product quality at low capital cost and environmental impact [41].

The apparent correlation between asphaltene precipitation and agglomeration, and its profound effect on water-in-diluted bitumen emulsion stability [42]has led many researchers to study the bulk precipitation of asphaltenes in order to define the appropriate conditions for the bitumen recovery processes, in which bulk precipitation is undesirable (e.g., SAGD and NFT) or required (e.g., PFT). For each solvent, a critical S/B ratio (also referred to as critical dilution) has been determined that coincides with the onset of bulk asphaltene precipitation, at which properties of the system change abruptly [30,43]. Just above the critical dilution, the addition of solvent yields oil product with very low residual water and solids contents, whereas below the critical dilution the fine water droplets remain dispersed in the oil phase. Accordingly, the recovery processes are designed to operate below or above the critical S/B ratio or critical dilution, by using lower aliphatic solvent addition volumes (SAGD); using solvent with relatively low paraffinic and high aromatic content such as naphtha (NFT) or solvents with predominantly aliphatic content and high S/B ratio (PFT). Despite the numerous studies, oil producers often experience process disruptions, such as undesirable stable emulsions, known as “rag layers” [19,44]. The occurrence of such issues below the critical dilution underlines the need to investigate further the mechanisms of water-diluted bitumen separation.

Recent findings strongly suggest that the properties of the water-diluted bitumen interface could be equally important to bulk precipitation in providing a deeper mechanistic understanding of the behavior of these complex water-in-diluted bitumen emulsions. The thin liquid film (TLF) technique using Scheludko-Exerowa cell [45,46,47] that enables the investigation of an emulsion model system of thin layers of continuous phase separating two approaching liquid droplets at nanoscale distances has been adapted and applied to water-in-oil emulsions [32,48,49]. The TLF studies of Tchoukov and co-workers have revealed substantial changes in the film rheological properties of the continuous oil phase from a Newtonian (liquid-like) to a non-Newtonian (gel-like) behavior as the paraffinic content of the solvent is increased and the S/B ratios are at and above the critical dilution [32,33,35]. In micropipette and microcollider experiments, Dabros et al have demonstrated that above the critical S/B ratio water/oil interfaces become “rigid” [52]. As demonstrated in the previous example, the inventors have demonstrated the existence of a transition region between the NFT and PFT process conditions in a paraffinic content range intermediate of NFT and PFT. This bench-scale study shows that at specific solvent paraffinic content, the oil product obtained in the transition region is virtually free from residual water and solids (<0.1 wt %), using gravity settling alone, as in the PFT, and the asphaltene are retained in dissolve state, as in the NFT (see Example 1). These TLF and transition region studies suggest that the oil-water separation mechanism changes with the paraffinic solvent content and prior to the onset of bulk asphaltene precipitation. The results reported to date highlight the need to understand the mechanisms of the asphaltene precipitation progression at the water-diluted bitumen interface in the transition region and its implications on the coalescence-agglomeration transition.

In the present example, the behavior of water-in-diluted bitumen emulsions were explored at macro- and microscopic scales in the conditions below and above critical dilution to provide insights at conditions near critical dilution. In the bench scale, bitumen froth treatment settling experiments in the transition region between NFT and PFT highlighted the possibility to attain effective water and solids separation without any noticeable bulk asphaltene precipitation. Light microscopy images revealed the inhibition of water droplet coalescence and the initiation of agglomeration in the oil continuous phase below critical dilution. TLF evidence showed structural changes in the contact zone between water droplets at similar conditions at the nanoscale. Without wishing to be bound by theory, these findings lead to the proposal of an alternative asphaltene precipitation at the water-oil interface that helps explain the occurrence of agglomeration at conditions below critical dilution.

Experimental

Materials

The naphtha and bitumen froth used to perform the bitumen froth treatment experiments were obtained from the Base Plant operation of Suncor Energy in Alberta. The bitumen froth samples were stored at room temperature in sealed containers to prevent evaporation. The bitumen froth was re-homogenized at 50° C. and subsampled prior to each experimental run to ensure the uniform and consistent distribution of froth components. The bitumen froth composition was 63.1 wt % bitumen, 23.6 wt % water and 12.6 wt % solids. The bitumen fraction contained 17.5 wt % asphaltenes. Based on these amounts, the bitumen froth employed in the present example is representative of typical bitumen froth produced from oil sands.

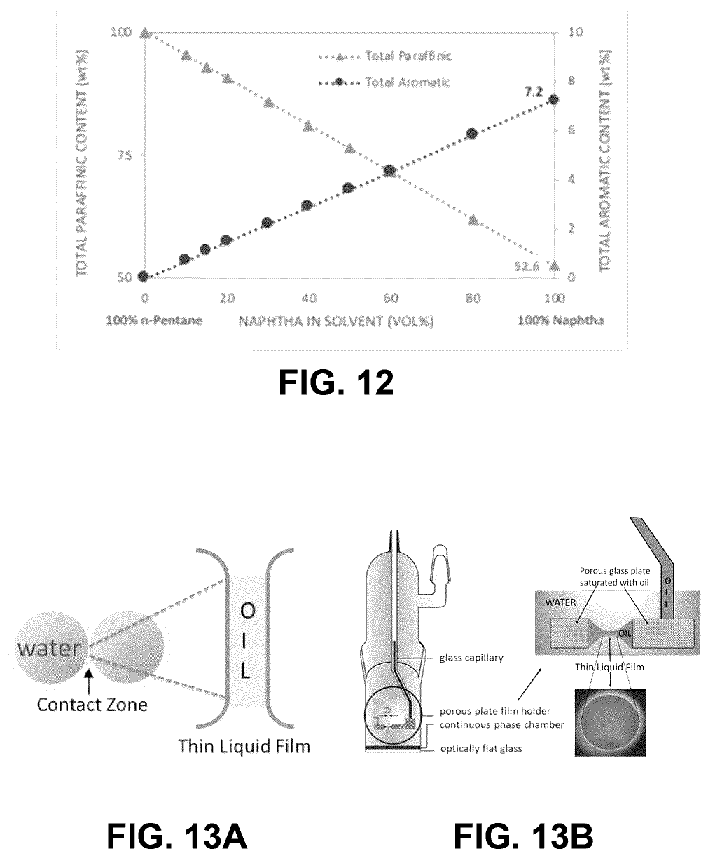

The naphtha samples were analyzed using the gas chromatographic PIONA (Paraffins, Isoparaffins, Olefins, Naphthenes and Aromatics) method conducted using Agilent 7890™ with vacuum ultraviolet detector, GC-VUV Analytics, Inc., Austin TX, USA, to determine the hydrocarbon composition, aromatic and paraffinic contents. The total paraffinic and aromatic contents of the naphtha used for dilution were 52.6 wt % and 7.23 wt %, respectively. The contributions of naphthenes (37 wt %) or specific aromatics, such as benzene, toluene and xylenes, could also potentially influence the asphaltene precipitation in different samples. The total aromatic and paraffinic contents in the solvent blends of 0 to 100 vol % naphtha/n-pentane were calculated based on the original naphtha content and presented in FIG. 12.

The froth treatment was conducted at an S/B ratio of 1.6 by volume using a set of solvent blends of naphtha with lab-grade n-pentane ranging from 0 to 100 vol % naphtha/n-pentane at 5, 10 or 20 vol % increments. The densities of the naphtha/n-pentane blends were determined using Anton Paar DMA 4500 densitometer at 25° C.

A produced water-in-oil emulsion from an Athabasca mining facility was used for the microscopic images. The images were collected 8 hours after subsampling of the des alter in the production plant.

Experimental Methods and Procedure

Froth treatment settling experiments. The mixing of bitumen froth and solvent was performed using a one-liter (1-L) closed mixing batch setup of a marine impeller and a baffler, custom-designed to prevent solvent loss and assure optimal mixing conditions. The mixing time of 15 min, rotational speed of 600 RPM, and S/B ratio of 1.6 were selected based on experimental protocols developed in CanmetENERGY Devon [36]. The retention of light ends was validated by performing a mass balance assessment Immediately after the mixing for 15 min, the diluted froth was transferred to a 500-mL graduated cylinder for settling. Fibre-optic illumination was used for improved contrast. The position of the settling interface was visually tracked and recorded at 30 s intervals. Additional details on the experimental setup and procedures are provided in Example 1.

Subsample analysis. The water content in overflow was determined by Karl Fischer titration (V20 Mettler Toledo). The solids content in overflow was determined by high-speed centrifugation (20,000 g), followed by vacuum filtration of the supernatant through 0.22 μm solvent-resistant filter paper. All samples were dried in the oven at 80° C. for 30 minutes. The results from duplicate analyzes agree within the experimental error of 0.001 wt %. The asphaltene content in tailings was determined (in duplicates) by using Dean-Stark analysis, followed by solvent-free bitumen rotary evaporation and C₅-precipitation/filtration. The heavy ends of naphtha may remain in bitumen during rotary evaporation, causing an error of 0.5-1.0 wt % in the asphaltene content determination, which is below the experimental error of ±3%.

Optical microscopy. Zeiss-Axio Imager Polarized Light microscope at bright field and transmitted light settings and magnifications of ×200 and ×1000 was used to obtain the microscopic images of produced fluid water-in-diluted bitumen emulsions. The images were subsequently analyzed to estimate the size of the droplets and particles in the emulsion. Glass slides with a depression and a glass cover were used as sample holders to prevent the evaporation of the volatile solvent fraction.

Thin liquid films. Thin liquid films are formed in the contact zone when two droplets in emulsion approach each other at a close distance. In contact zone, the droplets interfaces (water droplets in this case) interact with each other throughout the thin layer of continuous phase (oil in this case) (FIG. 13-a). The possible outcomes from this interaction may lead to either the coalescence of the droplets, if the thin film continuous phase drains out and the film ruptures at its critical thickness, or the formation of a stable emulsion film, if the continuous phase drainage ceases at some equilibrium thickness, balanced by stabilizing surface forces.

The water-in-oil emulsion films were generated in a Scheludko-Exerowa cell and studied using the TLF technique (FIG. 13-b). This technique allows to model emulsion interactions by studying the liquid film formed in the contact zone between two approaching emulsion droplets in a continuous phase in well controlled conditions at the microscopic level. A porous glass plate film holder with a small whole (diameter ˜0.8 mm) was soaked in the studied diluted bitumen then carefully immersed in the water-filled bottom part of a measuring cell. In order to improve the wettability for oil, the porous glass plate holder was treated hydrophobic by soaking in a 20% dichlorodimethylsilane (>99.5% purity Fluka, Sigma-Aldrich Corp.) in cyclohexene (ACS reagent grade, Fisher Scientific) solution for 24 hours. The TLF experiments were conducted at S/B ratio of 1.6 in toluene, representative of conditions below the critical dilution, and S/B ratio of 3 in heptane, representative of conditions greatly exceeding the critical dilution. The films were formed by slowly withdrawing oil solution from the porous plate attached to the glass capillary, using a micro-syringe until the two biconcave menisci in the hole approached each other and formed a plane parallel film. The film radius was adjusted to about 100 μm and the films were left to drain to either equilibrium thickness or rupture. The equilibrium thickness is determined by the balance of surface forces in the film and can be as low as 4 nm for water films stabilized with low molecular weight surfactants [47]. The equilibrium thickness of diluted bitumen films is typically in the range of 10-80 nm [32,53]. The films were observed, and images recorded in reflected light by using a Carl Zeiss Axio Observer inverted microscope and a high-resolution digital camera (Leica DFC500).

Results

Bitumen Froth Treatment

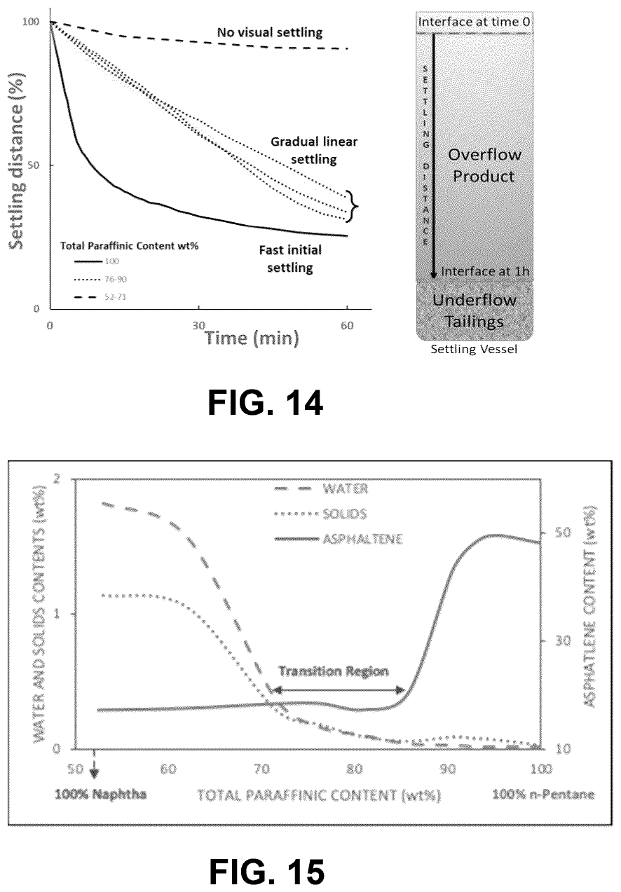

Presented in FIG. 14 (Left) are the settling results of bench-scale froth treatment experiments conducted at S/B ratio of 1.6 using solvents with high, low and intermediate paraffinic contents, representative of the PFT, NFT and transition region, respectively. A schematic representation of the settling vessel is shown in FIG. 14 (Right), where the overflow (hydrocarbon product), underflow (tailings) and settling interfaces at the times of 0 and 1 hour are marked. Presented in FIG. 15, are the water and solids contents in the overflow product and asphaltene content in the underflow tailings after the completion of settling, as a function of the total paraffinic content of the solvent.

The settling profiles in FIG. 14 highlight the distinct fast initial, no visual and gradual linear settling behaviors. The fast initial settling behavior (solid line), representative of the high total paraffinic content at 100 wt %, is due to asphaltene precipitation in the bulk oil phase and its agglomeration with water droplets and solids. The agglomerates visually appear as a cake-like structure and as a clear settling interface with fast settling under gravity in the initial 30 min or less, as in PFT. In FIG. 15, the residual water and solids contents in the oil product for the fast initial settling are 0.1 wt % or less. The asphaltene content in the froth treatment tailings, expressed as solvent-free bitumen in tailings (FIG. 15) reaches the value of ≈50 wt %, of which 32.5 wt % are precipitated during the froth treatment and 17.5 wt % are present in the original froth. The asphaltene content in the tailings decreases sharply, reaching the 17.5 wt % in the original froth, as the paraffinic content in the solvent is decreased.

No visual settling (dashed line in FIG. 14) is typical for the low paraffinic content range of 52-71 wt %. This settling behavior occurs without any asphaltene precipitation and agglomeration, as the water-oil separation occurs by coalescence, like in NFT. The settling by gravity for both water droplets and solids has a vertical distribution determined by their size, following the Stokes law [54]. However, the fine particles and droplets remain dispersed, as 1 hour is not sufficient for these to travel the settling distance. In this settling behavior, no visible upper settling interface is observed and the tailings have loose amorphous texture, as in NFT, in contrast with the cake-like structure typical for PFT [3,9]. The no visual settling regime corresponds to residual water and solids contents in the oil product in the range of 1-2 wt % (FIG. 15). The residual water and solids contents decrease substantially, as the total paraffinic content increases. The asphaltene content in tailings is nearly constant and close to 17.5 wt %, as in the original froth.

The gradual linear settling (solid lines in FIG. 14) occurs at the total paraffinic contents of 71-90 wt %, intermediate between NFT and PFT conditions. The settling interface is visible but not as clear as in PFT. The tailings are gel-like with some liquid, distinct from the cake-like and loose tailings observed at fast initial and no visual settling, respectively. The water and solids contents (FIG. 15) in the oil product are at, or below the 0.1 wt % target, as in PFT, and the asphaltene content in the tailings is comparable with that the original froth (17.5 wt %), as in NFT. The gradual linear settling behavior, low water and solids contents, and asphaltene content comparable to that of the original froth are representative of the transition region (see Example 1).

Microscopic Images of Produced Fluids from Oil Sands

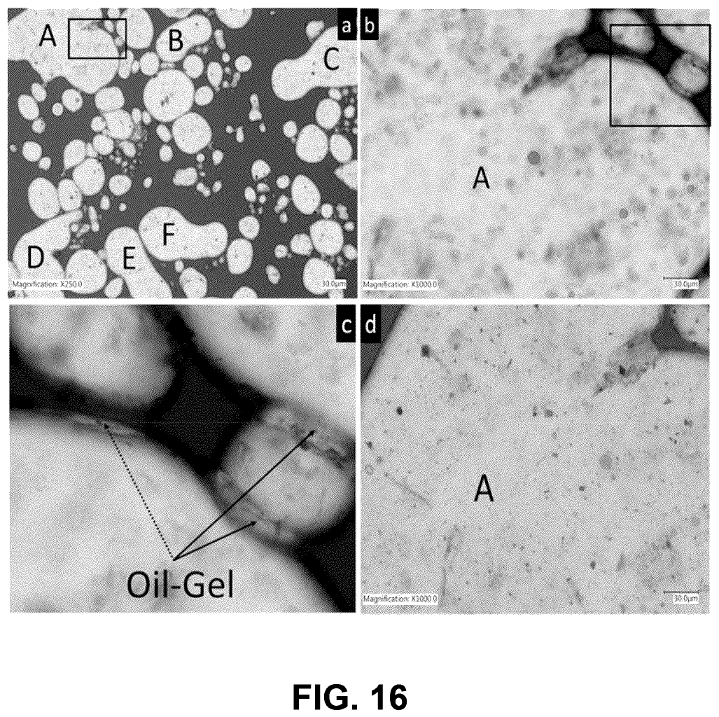

Presented in FIG. 16 are the optical microscopy images of a diluted bitumen sample captured approximately 8 hours after sampling from a production plant. The bitumen are treated with naphtha (solvent chosen to perform below critical dilution), with the intent to separate the oil phase from the water phase by coalescence. The water droplets, shown as light areas, are dispersed in the continuous phase of diluted bitumen, shown in light brown. In FIG. 16-a, captured at ×250 magnification, it is evident that the water droplets in the areas labeled as A-F, have coalesced, merging into larger water domains with irregular shape. The rest of the water droplets are still dispersed in the oil continuous phase and appear to retain their original spherical shape, forming a stable water-in-oil emulsion. The presence of such a stable emulsion after 8 hours indicates that coalescence, even though it is probable, has been partially inhibited.

The area outlined with the black rectangle in FIG. 16-a highlights a contact zone between water droplets. Upon a magnification ×1000 of this outlined area (FIG. 16-b), a dense formation in the contact zone between the water droplets becomes noticeable. This dense formation visually appears as gel-like, similar to the formations with a gel-like behaviour reported in the contact zone of TLF experiments from Tchoukov et al [32]. Therefore, the dense appearance formations found in the microscopic images in FIG. 16 are referred to as (oil) gel-like.

In FIG. 16-c, the area of interest, outlined in a black rectangle of FIG. 16-b is further zoomed-in with the software to highlight the contact zone between adjacent water droplets, which are fully occupied by the gel-like formation (indicated with black arrows). In the area indicated with a dashed arrow, the contact zone is only partially occupied on one side by the gel-like formation, while the rest of the contact zone remains a channel of a liquid continuous oil phase, as classified based on the light brown color, suggesting an early stage or onset of the establishment of an oil gel-like formation.

In FIG. 16-d, the area shown is similar to FIG. 16-b and the focus is on the internal substance of the water droplets, where there is a fine reverse oil-in-water emulsion and solids-in-water suspension. This emulsion is referred to as reverse because the water inside the water droplet is considered the continuous phase. In the reverse emulsion, several dispersed individual oil droplets (in light brown color) with a regular spherical shape, ranging from 2 to 10 μm are clearly visible, along with suspended fine mineral particles with irregular shape (in dark brown and black colors) that are smaller than 10 μm.

Thin Liquid Films

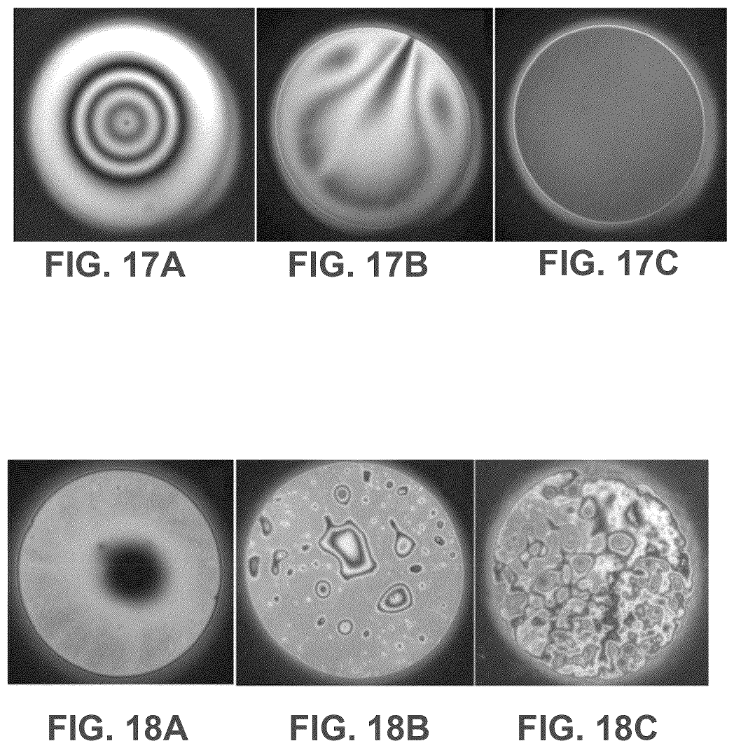

The evolution of film drainage is shown in FIG. 17-a-c, and FIG. 18-a-c, at conditions below and above critical dilution, respectively. The optical observation of a variety in the colors represents a heterogeneous film thickness, whereas a uniform color throughout the film corresponds to a homogeneous film thickness. The dimple-colorful fringes in the images FIG. 17-a and FIG. 17-b represent areas with greater film thickness and have hydrodynamic origin in the early stages of film formation and drainage evolution. Once the excess amount of liquid drains out, see FIG. 17-c, a plane parallel film is formed as the film continues draining out until an equilibrium homogeneous (grey) thickness is reached. The direction of drainage is visible in the upper right film edge of FIG. 17-b. The film remains intact for 15 min. The drainage time in these conditions is in the range of 2 min or less, representative of a fluid-like behaviour of the continuous phase.

In the early stages of film evolution above the critical dilution, shown in FIG. 18-a, a small dimple is visible in the centre that drains out in about 30 min, which is an indication that the drainage is considerably slower in comparison with the films formed below critical dilution (FIG. 17). Multiple small black dots appear in the film, most likely due to the precipitation of nano-sized asphaltene aggregates at the interface. With film evolution in FIG. 18-b, colorful patterns start to develop around the black dots indicating increasing film thickness in these areas. It must be noted that the colorful formations keep expanding until the entire film surface area is occupied (FIG. 18-c). This colorful image shows the development of a “rigid” interface and a relatively thick film with a heterogeneous thickness, indicative of a transition to oil gel-like film properties [32].

The possibility to separate the two droplets interfaces in contact was examined by slowly pumping the oil continuous phase back into the film. It was possible to increase the thickness of the films formed below critical dilution conditions (FIG. 17), which corresponds to a separation of the emulsified droplets. However, using conditions above critical dilution (FIG. 18-c), it was not possible to separate the film interfaces by pumping liquid back into the film, which indicates that the droplets are bonded together and cannot be easily separated due to a possible agglomeration.

### DISCUSSION

Settling Behaviour

The froth treatment results (FIG. 14 and FIG. 15) reveal a range of paraffinic solvent content, referred to as the transition region, where the settling behavior is intermediate between those of NFT and PFT. The characteristic and highly desirable feature of this transition region is a gradual linear settling that yields large amounts of high quality oil product without asphaltene loss in the tailings. This finding challenges the conventional understanding that bulk asphaltene precipitation drives both agglomeration and effective oil-water separation in PFT [12,13]. Moreover, the SB ratio of 1.6 (typical for PFT), a very important process condition, is determined based on the observation of the occurrence of bulk asphaltene precipitation. Considering that coalescence by gravity cannot deliver oil product with such low water and solids contents, the likely separation mechanism in the transition region would be a type of agglomeration that may not be driven by bulk asphaltene precipitation. Hence, agglomeration can occur at conditions below the critical dilution and be attributed to the modified solvent composition in terms of its paraffinic and aromatic content. The occurrence of agglomeration without bulk asphaltene precipitation is a particularly attractive for an effective froth treatment process using the conditions of the transition region (see Example 1).

Microscopy

In the optical microscopy images (FIG. 16), the presence of a stable emulsion after 8 hours indicates that coalescence, even though it is probable, has been partially inhibited. The inhibition could be attributed to the presence of a gel-like formation observed only in the contact zone between adjacent water droplets. Moreover, the presence of a partially formed gel-like structures along with several fully formed gel-like structures in contact zones could be indicative of the relatively slow kinetics of the establishment of these formations at conditions below critical dilution. The presence of gel-like formations in different stages suggests that these structures could be responsible for the initiation of agglomeration between adjacent droplets and contribute to both coalescence inhibition and emulsion stabilization. An important observation is the absence of asphaltene precipitates in the bulk oil continuous phase, which indicates that upon aging these droplets could initiate agglomeration without bulk asphaltene precipitation. Unlike the PFT agglomerates that contain distinct water droplets, solid particles, and asphaltene precipitates held together by the latter, based on FIG. 16-c, it is reasonable to envision that agglomerates would form, bonded by the gel-like structures in the contact zone in conditions below critical dilution, without bulk asphaltene aggregates. These microscopic level agglomeration results can be related to the settling results (FIG. 14 and FIG. 15) in order to provide important insights into the formation of gel-like structures in the contact zone, as a possible explanation of agglomeration below critical dilution, which is most likely cause for the undesirable occurrence of stable emulsion.

TLF Behaviour

The TLF images in FIG. 17 and FIG. 18 show considerable differences in the film drainage behaviour at conditions below and above critical dilution, respectively. While the fluid-like drainage and homogeneous critical thickness can be reached below critical dilution and at a relatively short time (2 min or less), the conditions above critical dilution demonstrate a relatively slow gel-like drainage behavior (more than 30 min). The reasons behind the observed abrupt changes in the fluid behaviour of the continuous phase can be attributed to the formation of small asphaltene aggregates in the water droplet contact zone upon drainage initiation (FIG. 18-a) and the formation of a rigid oil gel-like structure expanding around them (FIG. 18-b). Ultimately, the entire film area is occupied by the gel-like structure with a heterogeneous film thickness (FIG. 18-c). Since all solutions have been centrifuged prior to the TLF experiments in order to remove any fine solids and asphaltene precipitates, these small asphaltene aggregates are not bulk precipitates present in the solution initially but have formed in the film during the TLF experiment. The stabilization of TLFs above critical dilution has previously been attributed to the formation of a 3D network of asphaltenes that originates from the oil-water interfacial region, slowly extends into the film liquid, and bridges the two interfaces, resulting in a skin-like coating and causing an oil gel-like non-Newtonian TLF behaviour [32,33,49]. Such a fluid organization in TLF would promote the agglomeration of water droplets and the consequent formation of large agglomerates encompassing several droplets that facilitate the fast settling and efficient oil separation central to PFT. It is important to note that in industrial froth treatment, unlike in TLF model experiments, the solid particles would remain in the suspension and most likely will become incorporated into the agglomerates, accelerating the settling by gravity.

The possibility to separate the droplets by weak agitation after encounter and before their coalescence would leave many fine, micrometer size water droplets emulsified in the solution and agrees with the slow gravity settling behavior (FIG. 14) and resultant high residual water content in the oil product in the NFT regime (FIG. 15), at conditions below critical dilution. The nano-sized asphaltene aggregates and gel-like formations (FIG. 18) that initiate agglomeration in TLF appear analogous to the dense formations in water droplet contact zones in the microscopic images of the produced fluid (FIG. 16).

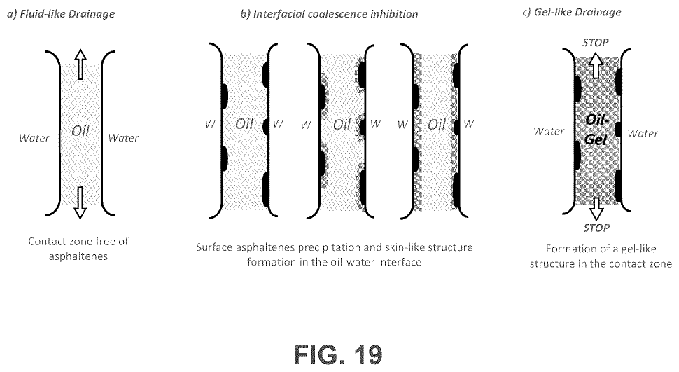

Based on the results and observations at bench scale froth treatment, microscopy and TLF experiments, in FIG. 19, a schematic representation of the progression of the interactions in the contact zone below and above the critical dilution conditions (at the specific S/B ratio) was developed. Below critical dilution (corresponding to TLF in FIG. 17), the oil phase can drain out of the contact zone by fluid-like drainage behavior (FIG. 19-a), allowing the two interfaces to come to a close contact.

In FIG. 19-b, the progression of coalescence inhibition by asphaltene precipitation at the interface is shown in three stages corresponding to the TLF experiments in FIG. 18-a to FIG. 18-c, above critical dilution. In the first stage of interfacial coalescence inhibition (FIG. 19-b), the oil-water interface is partially occupied by surface asphaltene aggregates, shown as black spots. In the second stage (FIG. 19-b), a gel-like formation develops (shown as red spots and a mesh) and envelops the asphaltene aggregates. In the third stage, the gel-like structure extends and forms a fully developed skin-like coating over the entire contact zone. These changes from partially to fully occupied interfaces would progressively inhibit the coalescence probability until it approaches zero. The outcome of decreasing the coalescence probability would be the formation of a very stable emulsion, where the water droplets retain their original sizes. The process would continue with the formation of a gel-like structure in the entire contact zone (FIG. 19-c), where drainage is fully stopped. With gelled contact zones, the water droplets would become “glued” to each other by the gel-like structure, thus initiating the formation of agglomerates, FIG. 16-c). In this stage, Tchoukov at al. have reported changes in the rheology of the continuous phase in the contact zone to non-Newtonian, with a Bingham yield stress sufficient to prevent film drainage [32,33].

Surface Asphaltene Precipitation

To elucidate the separation and changes in the interfacial behavior of water-in-diluted bitumen emulsions at conditions below critical dilution or intermediate between NFT and PFT presented in FIG. 14-FIG. 18, we define a state of surface asphaltene precipitation at the oil-water interface. The proposed surface asphaltene precipitation would occur without any noticeable bulk asphaltene precipitation in the oil continuous phase, making it distinct from the bulk asphaltene precipitation characteristic of conditions above critical dilution. For the surface asphaltene precipitation to occur without any bulk precipitation, either the solvent addition must be lower than the critical dilution for bulk asphaltene precipitation or the solvent paraffinic content must be reduced. Initiated by nanoaggregates incorporated in a gel-like structure, the surface asphaltene precipitation would not only prevent the water droplets from coalescing but also keep these glued together, as shown in the TLF images (FIG. 18) and progression (FIG. 19). This scenario is also evident from the microscopic images in FIG. 16 that capture the gel-like formations occupying partially or fully the contact zone between adjacent water droplets without noticeable bulk asphaltene precipitates in the oil continuous phase. These findings effectively corroborate the occurrence of agglomeration below critical dilution that is based on the proposed concept of surface asphaltene precipitation and extend the current understanding of the interfacial progression from fluid-like to gel-like that has previously been reported to occur only at conditions above critical dilution [52].

In FIG. 20, the insights from the microscopic scale experiments (FIG. 16-FIG. 18) are applied to interpret the effect of the changes in the contact zone on the interactions among water (in blue), diluted bitumen (overflow in beige), asphaltenes (in black) and solids (in yellow) during froth treatment, in the context of the bench scale settling experiments (FIG. 14). This interpretation aims to relate the state of surface asphaltene precipitation proposed above with the oil-water separation mechanisms in the conditions of NFT, transition region and PFT. In NFT, the water-oil separation occurs at conditions below critical dilution by the mechanism of coalescence, which involves the merging of individual small water droplets into larger water droplets until domains of free water are formed. The oil product has relatively high residual water and solids contents. The asphaltene is retained in the overflow, denoted by the beige color being darker than that in PFT. The tailings have amorphous texture, distinct from the cake-like texture of the PFT tailings, and a relatively low hydrocarbon residue (highlighted by the light brown color). A layer of free water is found between the overflow and the tailings. In the conditions above critical dilution required for PFT, the water-oil separation occurs by the agglomeration of the water droplets, solids and precipitated asphaltene in the bulk phase. Hence the overflow product is partially deasphalted, as highlighted by the lighter beige color than that of the NFT overflow. The PFT delivers a bitumen product virtually free from residual water and solids. The rejected asphaltene is incorporated into cake-like tailings with higher hydrocarbon residue and volume, shown in dark brown in contrast with the light brown NFT tailings.

The transition region scheme in FIG. 20 features effective water and solids removal by agglomeration, as in PFT, and minimal hydrocarbon loss in the tailings, as in NFT, due to the retention of asphaltene in the oil product (denoted by the same dark beige color as in NFT). The cake-like tailings have relatively low volume and hydrocarbon residue, shown in the same light brown color as the NFT tailings, but without a noticeable free water phase. Building upon the insights from the oil gel-like formations in the water-oil interface and water droplet contact zone, presented here as well as in the works of Dabros et al. [44], Czarnecki et al. and Tchoukov et al. [32,33], it is herein proposed that the agglomeration in the transition region below the critical dilution without bulk asphaltene precipitation is distinct from that in PFT. In the transition region, agglomeration is driven by surface asphaltene precipitation and the appearance of oil gel-like formations in the contact zones between water droplets (and likely in contact zones with solids). In PFT, the agglomeration is driven by bulk asphaltene precipitation, according to the current understanding [12,13]. Moreover, FIG. 18 suggests that the PFT agglomerates most likely also contain oil gel-like formations in the contact zones, such as those in the transition region.

Conclusion

Evidence from microscopic and bench scale experiments is presented and discussed to provide novel insights into the behavior of water-in-diluted bitumen emulsions. Bench scale froth treatment settling profiles reveal a range of conditions between those of NFT and PFT, referred to as the transition region, where the paraffinic solvent content is below the critical dilution of bulk asphaltene precipitation. The transition region yields effective water and solids removal, as in PFT, and minimal hydrocarbon loss in the tailings by retaining the asphaltenes in the oil product, as in NFT. These highly desirable characteristics effectively combine the advantages and largely eliminate the drawbacks of NFT and PFT. At similar conditions, below critical dilution, optical microscopy images of water-in-oil emulsion show coalescence inhibition and agglomeration initiation in the absence of asphaltene precipitates in the bulk oil continuous phase. Agglomeration below critical dilution is attributed to the transformation of the oil continuous phase to a gel-like formation in the contact zone between adjacent water droplets that become “glued” to each other. The slow kinetics of this transformation is evident from the presence of both partially formed and fully formed gel-like structures, after emulsion aging for at least 8 hours. The TLF results show fast fluid-like and slow gel-like drainage behaviors at conditions below and above critical dilution, respectively. The gel-like behavior is attributed to the formation of asphaltene aggregates and oil gel structure in the water droplet contact zone. These interfacial changes cause the inhibition of the coalescence of adjacent droplets and the initiation of agglomeration.

Building upon the presented findings and recent literature evidence, it is proposed that unlike the agglomeration in PFT that is driven by bulk asphaltene precipitation, the agglomeration below critical dilution is driven by surface asphaltene precipitation initiated by the formation of gel-like structures in the contact zone. This proposed mechanism challenges the conventional understanding that bulk asphaltene precipitation drives both agglomeration and effective oil-water separation.

### REFERENCES

1. Clark, K. A.; Pasternak, D. S. Hot Water Separation of Bitumen from Alberta Bituminous sand. Ind. Eng. Chem. 1932, 24, 1410-1416.
2. Masliyah J., Czarnecki J, Xu, Z; Handbook On Theory and Practice of Bitumen Recovery from Athabasca Oil Sands ISBN 978-1-926832-03-6(v.1). 2011.
3. Shelfantook, W. A Perspective on the Selection of Froth Treatment Process. Can. J. Chem. Eng. 2004, 82, 704-709.
4. Rao, F; Liu, Q. Froth Treatment in Athabasca Oil Sands Bitumen Recovery Process:

A Review. Energy Fuels, 2013, 27, 7199-7207.
5. Chen, Q; Stricek, I; Cao, M; Gray, M; Liu, Qi; Influence of hydrothermal treatment on filterability of fine solids in bitumen froth Fuel, 2016, 180, 314-323.
6. Czarnecki, J. Encyclopedic Handbook of Emulsion Technology; J. Sjoblom: New York, 2001; pp 497-514.
7. Kirpalani, D. M.; Matsuoka, A. CFD Approach for Simulation of Bitumen Froth Settling Process-Part I: Hindered Settling of Aggregates. Fuel, 2008, 87, 380-387
8. Romanova, U.; Yarranton, H.; Schramm, L Towards the Improvement of the Efficiency of Oil Sands Froth Treatment. Can. Int. Pet. Conf. 2003, 1-5. Energy & Fuels Review 7207.
9. Czarnecki, J.; Masliyah, 2011, J.; Xu, Z. Handbook On Theory and Practice of Bitumen Recovery from Athabasca Oil Sands. ISBN 978-1-926832-16-6(v.2).
10. Gymerman, P.; Dougan, T.; Lorentz, J.; Mayr, C. Inventors and Nexen Inc., Athabasca Oil Sands Investment Inc., AEC Oil Sands Limited Partnership, Petro-Canada, Murphy Oil Company Ltd., Mocal Energy Ltd., Imperial Oil Resourced, Gulf Canada Resources Ltd., and Canadian Oil Sands Investment Inc., owners 2001. Stage Settling Process for Removing Water and Solids from Oil Sand Extraction Froth. Canadian Patent CA 230002, field Jun. 6, 2001 and issued Oct. 30, 2007.
11. Romanova, U.; Yarranton, H.; Schramm, L; Shelfantook, W. The Effects of Oil Sands Bitumen Extraction Conditions on Froth Treatment Performance. J. Can. Pet. Technol. 2006, 45, 36-45.
12. Long, Y.; Dabros, T.; Hamza, H. Structure of Water/Solids/Asphaltenes Aggregates and Effect of Mixing Temperature on Settling Rate in Solvent-Diluted Bitumen. Fuel, 2004, 83, 823-832.
13. Sztukowski, D.; Jafari, M.; Alboudwarej, H.; Yarranton, H. Asphaltene Self-Association and Water-in-Hydrocarbon Emulsions. J. Colloid Interface Sci. 2003, 265, 179-186.
14. Madge, D.; Garner, W. Theory of Asphaltene Precipitation in a Hydrocarbon Cyclone. Miner. Eng. 2007, 20, 387-394.
15. Long, Y.; Dabros, T.; Hamza, H. Stability and Settling Characteristics of Solvent-diluted Bitumen Emulsions. Fuel, 2002, 81, 1945-1952.
16. Kosior D., Ngo E., Xu Y, Aggregates in Paraffinic Froth Treatment: Settling Properties and Structure; Energy Fuels, 2018, 32, 8268-8276.
17. Pandey, S.; Ralli, D.; Saxena, A.; Alamkhan, W. Physicochemical Characterization and Applications of Naphtha. J. Sci. Ind. Res. 2004, 63, 278-282.
18. Gomez, J.; 2008 Diluent Naphtha Characterization DBM Addendum DRU 31 Volume 4-30-8-1. Calgary: Canadian Natural Resources Limited.
19. Yeung, A.; Dabros, T.; Czarnecki, J.; Masliyah, J. On the Interfacial Properties of Micrometre-sized Water Droplets in Crude Oil. Proc. R. Soc. Lond. A., 1999, 455, 3709-3723.
20. Eley, D.; Hey, M.; Symonds, J., Emulsions of water in asphaltene-containing oils 1. Droplet Size Distribution and Emulsification Rates. Colloids Surf. 1988, 32, 87-101.
21. Gafanova, O.; Yarranton, W. The Stabilization of Water-in Hydrocarbon Emulsions by Asphaltenes and Resins. J. Colloid Interface Sci. 2001, 241, 469-478.
22. Mercier, P.; Tyo, D; Zborowski, A; Kung, J.; Patarachao, B.; Kingston, D.; Martin Couillard, M.; Robertson,G.; McCracken, T.; Ng, S., First quantification of <2 μm clay, <0.2 μm ultrafines and solids wettability in process streams from naphthenic froth treatment plant at commercial mined oil sands operations; Fuel, 237, February 2019, 961-976.
23. Madge, D.; Romero, J.; Strand, W. Process Reagents for the Enhanced Removal of Solids and Water from Oil Sand Froth. Miner. Eng. 2005, 18, 159-169 Patrick H. J. Mercier, Daniel D. Tyo, Andre Zborowski, Judy Kung, Bussaraporn Patarachao, David M. Kingston, Martin Couillard, Gilles Robertson, Thom McCracken, Samson Ng First quantification of <2 μm clay, <0.2 μm ultrafines and solids wettability in process streams from naphthenic froth treatment plant at commercial mined oil sands operations; Fuel 237, February 2019, 961-976.
24. Stasiuk, E.; Schramm, L. The Influence of Solvent and Demulsifier Additions on Nascent Froth Formation during Flotation Recovery of Bitumen from Athabasca Oil Sands. Fuel Process. Technol. 2001, 73, 95-110.
25. Sun, T.; Zhang, L.; Wang, Y.; Zhao, S.; Peng, B.; Li, M.; Yu, J. Influence of Demulsifiers of Different Structures on Interfacial Dilational Properties of an Oil—Water Interface Containing Surface-Active Fractions from Crude Oil. J. Colloid Interface Sci. 2002, 255, 241-247.
26. Daniel-David, D.; Pezron, I.; Dalmazzone, C.; Noik, C.; Clausse, D.; Komunjer, L. Elastic Properties of Crude Oil/Water Interface in Presence of Polymeric Emulsion Breakers. Colloids Surf. A 2005, 270, 257-262.
27. Zhang, L.; Xu, Z.; Masliyah, J. Langmuir and Langmuir—Blodgett Films of Mixed Asphaltene and a Demulsifier. Langmuir 2003, 19, 9730-9741.
28. Garner, W.; Madge N.; Strand L.; Bituminous Froth Inclined Plate Separator and Hydrocarbon Cyclone Treatment Process. U.S. Pat. No. 7,438,807B2, 2009.
29. Madge, D. Romero, J.; Strand, W. Hydrocarbon Cyclones in Hydrophilic Oil Sand Environments. Miner. Eng. 2004, 17, 625-636.
30. Czarnecki, J.; Moran, K. On the stabilization mechanism of water-in-oil emulsions in petroleum systems. Energy Fuels 2005, 19, 2074-2079.
31. Angle, C.; Long, Y.; Hamza, H.; Lue, L. Precipitation of Asphaltenes from Solvent-Diluted Heavy Oil and Thermodynamic Properties of Solvent-Diluted Heavy Oil Solutions. Fuel 2006, 85,492-506.
32. Tchoukov, P.; Czarnecki, J.; Dabros, T. Study of water-in-oil thin liquid films:
Implications for the stability of petroleum emulsions. Colloids Surf., A 2010, 372,
33. Tchoukov, P.; Yang, F.; Xu, Z.; Dabros, T.; Czarnecki, J.; Sjoblom, J. Role of asphaltenes in stabilizing thin liquid emulsion films. Langmuir 2014, 30, 3024-33.
34. Mozaffari S., Tchoukov P., Atias J., Czarnecki J., Nazemifard N.; Effect of Asphaltene Aggregation on Rheological Properties of Diluted Athabasca Bitumen. Energy Fuels 2015, 29, 5595-5599.
35. Czarnecki, J.; Tchoukov, P.; Dabros, T. Possible Role of Asphaltenes in the Stabilization of Water-in-Crude Oil Emulsions. Energy Fuels, 2012, 26, 5782-5786.
36. https://www.nrcan.gc.ca/energy/energy-sources-distribution/crude-oil/upgrading-oil-sands-and-heavy-oi1/5875.
37. Sharma A. K.; Raterman M. F. Optimizing Feed Mixer Performance in a Paraffinic Froth Treatment Process. U.S. Patent No.US 20090321322A1, 2009.
38. Zawala, J.; Dabros, T.; Hamza, H. A. Settling Properties of Aggregates in Paraffinic Froth Treatment. Energy Fuels, 2012, 26, 5775-5781.
39. Fan, Tianguang, Wang, Jianxin, And Jill S. Buckley. “Evaluating Crude Oils by Sara Analysis.” Paper Presented at The Spe/Doe Improved Oil Recovery Symposium, Tulsa, Oklahoma, April 2002. Doi: Https://Doi.org/10.2118/75228-Ms.
40. Czarnecki, J., Tchoukov, P., Dabros, T., & Xu, Z. (2013). Role of Asphaltenes In Stabilisation Of Water In Crude Oil Emulsions. The Canadian Journal of Chemical Engineering, 91(8), 1365-1371.
41. Beetege, H Et Al., Inventors; And Champion Technologies Inc and Syncrude Canada Ltd., Owners 2006 Zone Settling Aid and Method for Producing Dry Diluted Bitumen with Reduced Losses of Asphaltenes.
42. Y. Xu, T Dabros, H Hamza, W Shefantook; Destabilization of Water in Bitumen Emulsion by Washing with Water, Pet, Sci. Technol 17 (1999) 1051-1070.
43. Y Long, T Dabros, H Hamza, Selective Solvent Deasphalting For Heavy Oil Emulsion Treatment, In Mullins 0.C., Sheu E. Y., Hammami A, Marshall A. G. (eds) Asphaltenes, Heavy Oils, and Petroleomics. Springer, New York, NY (2007) 511-547.
44. Dabros, T.; Yeung, A.; Masliyah, J.; Czarnecki, J. Emulsification Through Area Contraction. J. Colloid Interface Sci. 1999, 210, 222-224.
45. Sheludko, Thin Liquid Films, Adv. Colloid Interface Sci. 1 (1967) 391-464.
46. Platikanov D., Exerowa D., “Thin Liquid Films”, In J. Lyklema, Eds., Fundamentals of Interface and Colloid Science, Academic Press, London, U K 2005.
47. D. Exerowa, P. M. Kruglyakov, Foam and Foam Films, Elsevier, New York, 1998.
48. K. Khristov, S. D. Taylor, J. Czarnecki, J. Masliyah, Thin Liquid Film Technique—Application to Water-Oil-Water Bitumen Emulsion Films, Colloids Surf. A 174 (2000) 183-196.
49. J Czarnecki, K Khristov, J Masliyah, N Panchev, Sd Taylor, P Tchoukov, Colloids and Surfaces A: Physicochemical and Engineering Aspects 519,2-10.
50. Yeung, T. Dabros, J. Masliyah, J. Czarnecki, Micropipette: A New Technique in Emulsion Research, Colloids Surf. A 174 (2000) 169-181.
51. X. Wu, I. Laroche, J. Masliyah, J. Czarnecki, T. Dabros, Applications of colloidal force measurements using microcollider apparatus to oil sand studies, ColloidsSurf. A 174 (2000) 133-146.
52. T. Dabros, A. Yeung, J. Masliyah, J. Czarnecki, Emulsification Through Area Contraction, J. Colloid Interface Sci. 210 (1999) 222-224.
53. H. Khristov, S. D. Taylor, J. Czarnecki, J. Masliyah, Thin Liquid Film Technique—Application to Water-Oil-Water Bitumen Emulsion Films, Colloids Surf. A 174 (2000) 183-196.
54. Stokes, G. G. (1851) On the Effect of the Internal Friction of Fluids on the Motion of Pendulums. Transactions of the Cambridge Philosophical Society, Part II, 9,8-106.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of obtaining diluted bitumen from a bitumen-containing mixture comprising bitumen, water and mineral solids, the method comprising:
(a) combining the bitumen-containing mixture with a solvent blend to obtain a combination having a ratio of said solvent blend to bitumen that is below the solvent to bitumen ratio corresponding to onset of bulk asphaltene precipitation, wherein said solvent blend comprises one or more aromatic components in an amount of from about 2.0 to about 4.7 wt % and one or more paraffinic components in an amount of from about 60 to about 90 wt %;
(b) mixing the combination; and
(c) separating the diluted bitumen product from the water and mineral solids.

2. The method of claim 1, wherein the ratio of solvent blend to bitumen is 1.6:1 by mass.

3. The method of claim 1, wherein the mixing step is performed until the bitumen-containing mixture is fully homogenized with the solvent blend.

4. The method of claim 3, wherein the mixing step is performed for from about 1 hour to about 15 minutes.

5. The method of claim 1, wherein the mixing step is performed using a mixing speed that provides homogenization of the bitumen-containing mixture with the solvent blend without emulsification.

6. The method of claim 5, wherein the mixing speed is about 600 RPM.

7. The method of claim 1, wherein the mixing and separating steps are performed at a temperature and pressure that is up to but below the temperature and pressure used for standard paraffinic froth treatments.

8. The method of claim 7, wherein the mixing and separating steps are performed at ambient temperature and pressure.

9. The method of claim 1, wherein the separating step (c) comprises gravity settling.

10. The method of claim 9, wherein the gravity settling time is up to about 1 hour.

11. The method of claim 1, wherein the solvent blend comprises naphtha.

12. The method of claim 11, wherein the naphtha is blended with one or more alkanes as a source of the one or more paraffinic components.

13. The method of claim 11, wherein the naphtha is blended with a gas condensate as a source of the one or more paraffinic components.

14. The method of claim 11, wherein the one or more paraffinic components comprises a C₃-C₁₀ alkane or a combination thereof.

15. The method of claim 11, wherein the naphtha comprises paraffinic, isoparaffinic, olefinic, aromatic and naphthenic components and combinations thereof.

16. The method of claim 1, wherein the one or more aromatic components are present in the solvent blend at an amount of from about 2.2 to about 4.5 wt % and the one or more paraffinic components are present in the solvent blend at an amount of from about 70 about 80 wt %.

17. The method of claim 1, wherein the bitumen-containing mixture is bitumen froth.

18. The method of claim 1, wherein the diluted bitumen product comprises: i) less than 0.1 wt % water; ii) less than 0.1 wt % solids; and iii) an asphaltenes content that is within about 3 wt % of the asphaltenes content in the bitumen-containing mixture.
